(19) United States
(12) Patent Application Publication
(10) Pub. No.: US 2026/0118799 A1
(43) Pub. Date: Apr. 30, 2026

(54) IMAGE FORMING APPARATUS

(71) Applicant: CANON KABUSHIKI KAISHA, Tokyo (JP)

(72) Inventors: IZURU TANAKA, Kanagawa (JP); YUICHI TANABE, Chiba (JP); SHINYA KITAGO, Chiba (JP)

(21) Appl. No.: 19/367,325

(22) Filed: Oct. 23, 2025

(30) Foreign Application Priority Data
Oct. 25, 2024 (JP) 2024-188678

(51) Int. Cl. G03G 15/16; G03G 15/00

(52) U.S. Cl. CPC G03G 15/161; G03G 15/80

(57) ABSTRACT

An image forming apparatus includes a photosensitive member, an intermediary transfer belt, a transfer member, an electrode member provided on a side downstream of the transfer portion with respect to a movement direction of the intermediary transfer belt and on an inner peripheral surface side of the intermediary transfer belt; and a power source configured to apply a voltage of the same polarity as a predetermined polarity to the electrode member. The electrode member has an uneven shape formed on a surface thereof opposing the inner peripheral surface of the intermediary transfer belt so that a plurality of contact portions each surface-contacting the inner peripheral surface of the intermediary transfer belt and a plurality of non-contact portions each in non-contact with the inner peripheral surface of the intermediary transfer belt are alternately formed with respect to a predetermined direction along the surface of the electrode member.

### FIELD OF THE TECHNOLOGY

The present disclosure relates to an image forming apparatus such as a copying machine, a printer, a facsimile machine, or a multi-function machine having a plurality of functions of these machines, using an electrophotographic type or an electrostatic recording type.

### DESCRIPTION OF THE RELATED ART

As an image forming apparatus, such as a color copying machine, a color printer, or a color multi-function machine, using the electrophotographic type, an image forming apparatus of an intermediary transfer type becomes mainstream since the image forming apparatus has advantages such that downsizing of an apparatus main assembly and adaptation to various recording materials are relatively easy. The image forming apparatus of the intermediary transfer type includes, in general, a constitution provided with a plurality of photosensitive drums and an intermediary transfer belt. Further, in such an image forming apparatus, toner images formed on the photosensitive drums are electrostatically primary-transferred successively onto the intermediary transfer belt in primary transfer portions. Then, the toner images primary-transferred on the intermediary transfer belt are electrostatically secondary-transferred onto a recording material such as paper in a secondary transfer portion. Incidentally, with respect to an arrangement of members around the primary transfer portions, "upstream" and "downstream" refer to "upstream" and "downstream", respectively, with respect to a conveying direction of the intermediary transfer belt unless otherwise particularly specified.

In the image forming apparatus as described above, toner on the intermediary transfer belt has a tendency such that on a side downstream of a primary transfer portion, the toner is subjected to electric discharge between the intermediary transfer belt and the photosensitive drum and thus a charge amount of the toner increases. Then, the charge amount of the toner on the intermediary transfer belt increases, so that it becomes hard to transfer the toner onto a recording material in the secondary transfer portion in some instances. For example, a secondary transfer electric field necessary to transfer the toner onto the recording material in the secondary transfer portion becomes large, so that graininess of the image becomes worse and uniform transfer of the toner onto embossed paper with surface unevenness or the like becomes difficult in some instances.

Here, in Japanese Laid-Open Patent Application No. 2003-57963, a constitution in which an electroconductive contact plate is provided on a side downstream of the primary transfer portion and on an inner peripheral surface side of the intermediary transfer belt and in which a bias of the same polarity as a charge polarity of a photosensitive drum is applied to the contact plate is disclosed.

In order to suppress the increase in charge amount of the toner on the side downstream of the primary transfer portion as described above, suppression of the electric discharge on the side downstream of the primary transfer portion is effective. Further, in order to suppress this electric discharge, it is effective that a potential difference between the photosensitive drum and the intermediary transfer belt after the toner passes through the primary transfer portion is made small. Further, for that purpose, it is effective that an electroconductive electrode member is provided on the side downstream of the primary transfer portion and on the inner peripheral surface side of the intermediary transfer belt and the bias of the same polarity as the charge polarity of the photosensitive drum is applied to this electrode member.

However, in the case where a relatively high bias is applied to the electrode member or the like case, an electrostatic adsorption force between the intermediary transfer belt and the electrode member increases, so that a traveling property of the intermediary transfer belt becomes unstable in some instances.

### SUMMARY

The present disclosure is directed to suppress that a traveling property of an intermediary transfer belt in a constitution in which a bias is applied to an electrode member provided downstream of an primary transfer portion.

This is achieved by an image forming apparatus according to the present disclosure.

According to an aspect of the present disclosure, there is provided an image forming apparatus comprising: a photosensitive member capable of being electrically charged to a predetermined polarity and configured to bear a toner image; an intermediary transfer belt configured to convey the toner image transferred from the photosensitive member and capable of being circulated and moved; a transfer member forming a transfer portion, where the photosensitive member and the intermediary transfer belt contact each other, in contact with an inner peripheral surface of the intermediary transfer belt, and configured to transfer the toner image from the photosensitive member onto the intermediary transfer belt in the transfer portion under application of a voltage; an electrode member provided on a side downstream of the transfer portion with respect to a movement direction of the intermediary transfer belt and on an inner peripheral surface side of the intermediary transfer belt; and a power source configured to apply a voltage of the same polarity as a predetermined polarity to the electrode member, wherein the electrode member has an uneven shape formed on a surface thereof opposing the inner peripheral surface of the intermediary transfer belt so that a plurality of contact portions each surface-contacting the inner peripheral surface of the intermediary transfer belt and a plurality of non-contact portions each in non-contact with the inner peripheral surface of the intermediary transfer belt are alternately formed with respect to a predetermined direction along the surface of the electrode member.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic block diagram of a control system of the image forming apparatus.

Parts (a) and (b) of FIG. 3 are a schematic sectional view and a schematic perspective view, respectively, of a potential regulating member.

FIG. 4 is a schematic sectional view of the potential regulating member in another example.

FIG. 5 is a schematic sectional view of the potential regulating member in another example.

FIG. 6 is a schematic sectional view for illustrating an arrangement of the potential regulating member.

Parts (a) and (b) of FIG. 7 are a plan (top) view and a sectional view, respectively, showing a surface shape of a potential regulating member in an embodiment 1.

Parts (a) and (b) of FIG. 8 are a plan view and a sectional view, respectively, showing a surface shape of a potential regulating member in an embodiment 2.

Pats (a) and (b) of FIG. 9 are a plan view and sectional view, respectively, showing a surface shape of a potential regulating member in an embodiment 3.

Parts (a) and (b) of FIG. 10 are a plan view and a sectional view, respectively, showing a surface shape of a potential regulating member in an embodiment 4.

Parts (a) and (b) of FIG. 11 are a plan view and a sectional view, respectively, showing a surface shape of a potential regulating member in an embodiment 5.

Parts (a) and (b) of FIG. 12 are a plan view and a sectional view, respectively, showing a surface shape of a potential regulating member in another embodiment.

FIG. 13 is a sectional view, for illustrating a problem, in the neighborhood of primary transfer portion.

### DESCRIPTION OF THE EMBODIMENTS

In the following, an image forming apparatus according to the present disclosure will be described in more detail with reference to the drawings.

### Embodiment 1

### 1. General structure and operation of image forming apparatus

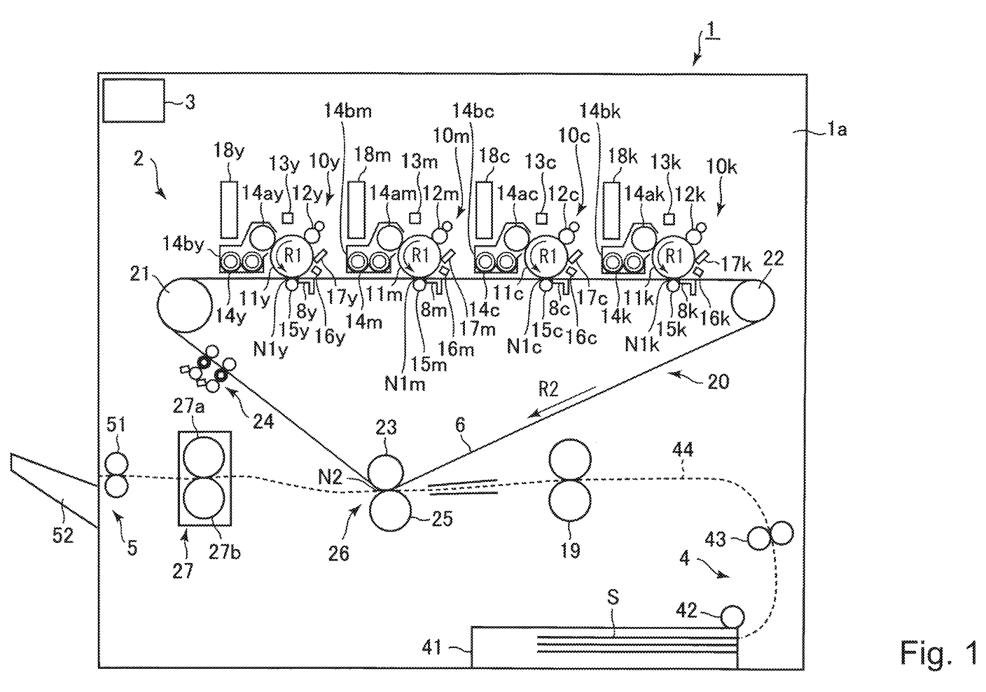

First, a general structure and an operation of the image forming apparatus of this embodiment will be described. FIG. 1 is a schematic sectional view of an image forming apparatus 1 of this embodiment. The image forming apparatus 1 of this embodiment is a tandem type full-color printer capable of forming a full-color image on a sheet-like recording material S by using an electrophotographic type and employing an intermediary transfer type.

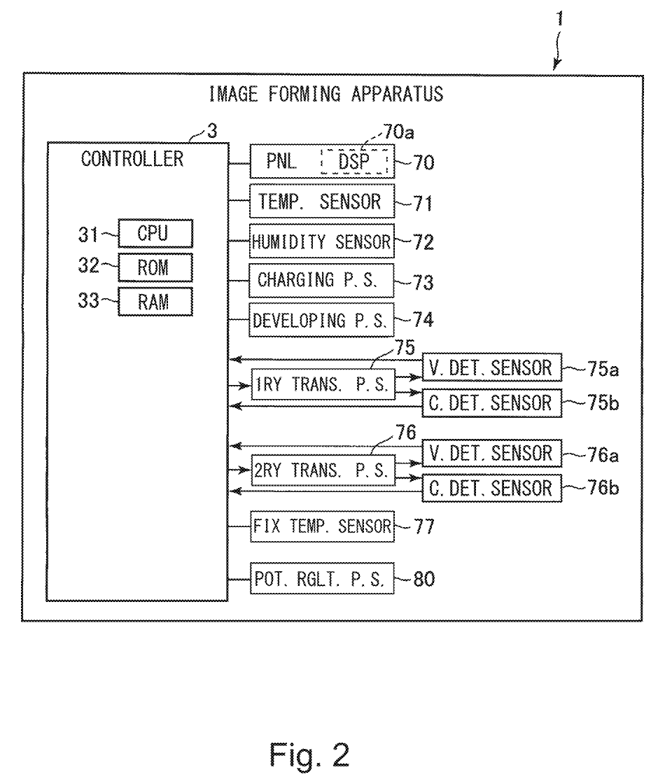

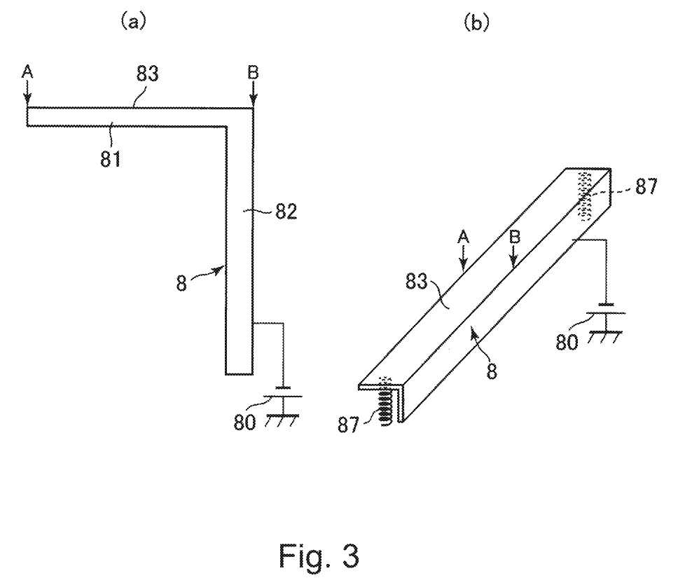

The image forming apparatus 1 includes image forming portion 2, a controller 3, a feeding portion 4 of the recording material S, and a discharging portion 5 of the recording material S. Further, inside the image forming apparatus 1, a temperature sensor 71 (FIG. 2) capable of detecting a temperature inside the apparatus and a humidity sensor 72 (FIG. 2) capable of detecting a humidity inside the apparatus are provided. The image forming apparatus 1 is capable of forming an image on the recording material S on the basis of image information (image signal) acquired by an original reading apparatus (not shown) provided on the image forming apparatus 1 or connected to the image forming apparatus 1. Further, the image forming apparatus 1 is capable of forming an image on the recording material S on the basis of image information (image signal) from an external device (not shown), such as a personal computer (host device), a digital camera, or a smartphone, connected to the image forming apparatus 1. Incidentally, the recording material (transfer material, recording medium, sheet) S is a material on which a toner image is formed. Specific examples of the recording material S include plain paper, thick paper, gloss coated paper, mat coated paper, embossed paper, or synthetic resin sheets (synthetic paper) which are substitutes for plain paper or the like, and an overhead projector sheet (resin film). Here, the recording material S is referred to as "paper" ("paper", "embossed paper", "high-resistance paper", or the like) in some instances, but even in that case, the recording material S includes a material other than the paper or a recording material formed with a material containing the material other than the paper.

The image forming portion 2 forms the image on the recording material S, fed from the feeding portion 4, on the basis of the image information. The image forming portion 2 includes image forming units 10y, 10m, 10c, 10k, toner bottles 18y, 18m, 18c, 18k, exposure devices 13y, 13m, 13c, 13k, an intermediary transfer unit 20, a secondary transfer device 26, and a fixing device 27. The image forming units 10y, 10m, 10c and 10k form toner images of colors of yellow (y), magenta (m), cyan (c), and black (k), respectively. Incidentally, elements having the same or corresponding functions or structures provided for the respective colors will be collectively described by omitting suffixes y, m, c and k for representing elements for associated colors, respectively, in some instances. Further, the image forming apparatus 1 can also form, for example, a single-color image such as a (single) black image or a multi-color image by using the image forming unit(s) 10 for a desired single color or some of the four colors.

The image forming unit 10 includes a photosensitive drum 11 which is a drum-type (cylindrical) photosensitive member (electrophotographic photosensitive member) as an image bearing member. In addition, the image forming unit 10 includes a charging roller 12 which is a roller-type charging member as a charging means. In addition, the image forming unit 10 includes a developing device 14 as a developing means. In addition, the image forming unit 10 includes a pre-exposure device 16 as a discharging (charge eliminating) means. In addition, the image forming unit 10 includes a drum cleaning device 17 as a photosensitive member cleaning means. The image forming unit 10 forms a toner image on an intermediary transfer belt 6 described hereinafter.

The photosensitive drum 11 is movable (rotatable) while carrying (bearing) an electrostatic image (electrostatic latent image) or a toner image. In this embodiment, the photosensitive drum 11 is a drum-type photosensitive member provided with a negatively chargeable organic photosensitive member (OPC), and an outer diameter thereof is 30 mm. This photosensitive drum 11 is electrically chargeable to a negative polarity as a predetermined polarity. The photosensitive drum 11 includes an aluminum cylinder as a substrate and a surface layer (photosensitive layer) formed on the surface of the substrate. In this embodiment, as the surface layer, three layers of an undercoat layer, a charge generation layer, and a charge transportation layer, which are applied and laminated on the substrate in the order named are provided. When an image forming operation is started, the photosensitive drum 11 is rotationally driven in a direction indicated by an arrow R1 (counterclockwise) direction in FIG. 1 at a predetermined peripheral speed (process speed) by a driving motor (not shown) as a driving means.

The surface of the rotating photosensitive drum 11 is uniformly electrically charged by the charging roller 12. In this embodiment, the charging roller 12 is a rubber roller which contacts the surface of the photosensitive drum 11 and which is rotated with the rotation of the photosensitive drum 11. To the charging roller 12, a charging power source 73 (FIG. 2) as a charging voltage applying means (charging voltage applying portion) is connected. The charging power source 73 applies a predetermined charging voltage (charging bias) to the charging roller 12 during the charging process.

The surface of the charged photosensitive drum 11 is scanned and exposed by the exposure device 13 on the basis of the image information, so that an electrostatic image is formed on the photosensitive drum 11. The exposure device 13 is a laser scanner in this embodiment. The exposure device 13 emits laser beam (light) in accordance with separated color image information outputted from the controller 3, and scans and exposes the surface (outer peripheral surface) of the photosensitive drum 11.

The electrostatic image formed on the photosensitive drum 11 is developed (visualized) by supplying the toner thereto by the developing device 14, so that a toner image (toner picture, developer image) is formed on the photosensitive drum 11. In this embodiment, the developing device 14 is a two-component developing device using, as a developer, a two-component developer comprising toner (non-magnetic toner particles) and a carrier (magnetic carrier particles). In a developing container (developing container main body) 14b of the developing device 14, the two-component developer is accommodated, and toner in an amount corresponding to a consumed amount of the toner is supplied from the toner bottle 18. The developing device 14 includes a developing sleeve 14a as a developing member (developer carrying member). The developing sleeve 14a is constituted by, for example, a non-magnetic material such as aluminum or non-magnetic stainless steel (aluminum in this embodiment). Inside the developing sleeve 14a, a magnet roller (not shown) which is a roller-shaped magnet as a magnetic field-generating means (magnetic field-generating member) is fixed and arranged so as not to rotate relative to the developing container 14b. The developing sleeve 14a carries the two-component developer and conveys it to a developing region opposing the photosensitive drum 11. Then, in the developing region, the toner is moved to and deposited on an image portion of the electrostatic image on the photosensitive drum 1 from the two-component developer on the developing sleeve 14a. A developing power source 74 (FIG. 2) as a developing voltage applying means (developing voltage applying portion) is connected to the developing sleeve 14e. The developing power source 74 applies a predetermined developing voltage (developing bias) to the developing sleeve 14a during the development. In this embodiment, on an exposed portion (image portion) on the photosensitive drum 11 lowered in absolute value of the potential by being exposed after being uniformly charged, the toner charged to the same polarity (negative polarity in this embodiment) as the charge polarity of the photosensitive drum 11 is deposited (reverse development type). In this embodiment, a normal charge polarity of the toner, which is a principal charge polarity of the toner during the development, is the negative polarity.

The intermediary transfer unit 20 is arranged so as to oppose the four photosensitive drums 11y, 11m, 11c and 11k. The intermediary transfer unit 20 includes the intermediary transfer belt 6 which is constituted by an endless belt as an intermediary transfer member. The intermediary transfer belt 6 is wound around and stretched by, as a plurality of stretching rollers, a driving roller 21, a tension roller 22, and an inner secondary transfer roller 23. The intermediary transfer belt 6 is movable (rotatable, capable of being circulated and moved) while carrying the toner image. The driving roller 21 is rotationally driven by a driving motor (not shown) as a driving means, so that a driving force is transmitted to the intermediary transfer belt 6, and thus the intermediary transfer belt 6 is rotated (circulated and moved) in an arrow R2 direction (clockwise direction) in FIG. 1 at a predetermined peripheral speed corresponding to the peripheral speed of the photosensitive drum 1. The tension roller 22 controls the tension of the intermediary transfer belt 6 to be constant. The tension roller 22 is subjected to a force which pushes the intermediary transfer belt 6 from an inner peripheral surface (back surface) side toward an outer peripheral surface (front surface) side by an urging force of a tension spring (not shown) constituted by a compression coil spring which is an urging member as an urging means. By this force, a tension of about 2 to 5 kgf is applied to the intermediary transfer belt 6 in the feeding (conveying) direction (process progression direction, movement direction) of the intermediary transfer belt 6. The inner secondary transfer roller 23 constitutes a secondary transfer device 26 in combination with an outer secondary transfer roller 25 described hereinafter. On the inner peripheral surface side of the intermediary transfer belt 6, primary transfer rollers 15y, 15m, 15c, and 15k, which are roller-type primary transfer members as primary transfer means, are provided correspondingly to the photosensitive drums 11y, 11m, 11c, and 11k, respectively. In this embodiment, the primary transfer rollers 15 are disposed opposed to the photosensitive drums 11 and nip the intermediary transfer belt 6 between themselves and the photosensitive drums 11. Each of the primary transfer rollers 15 is pressed toward the photosensitive drum 11 and contacts the photosensitive drum 11 by way of the intermediary transfer belt 6, and forms a primary transfer portion (primary transfer nip) N1 which is a contact portion between the photosensitive drum 11 and the intermediary transfer belt 6.

The toner image formed on the photosensitive drum 11 is transferred (primarily transferred) onto the intermediary transfer belt 6 in the primary transfer portion N1 by the action of the primary transfer roller 15. For example, during formation a full-color image, the yellow, magenta, cyan and black toner images formed on the photosensitive drums 11 are multiple-transferred so as to be sequentially superimposed on the intermediary transfer belt 6. A primary transfer power source 75 (FIG. 2) as a primary transfer voltage applying means (primary transfer voltage applying portion) is connected to the primary transfer roller 15. During the primary transfer, the primary transfer power source 75 applies, to the primary transfer roller 15, a primary transfer voltage (primary transfer bias) which is a DC voltage having an opposite polarity (positive polarity in this embodiment) to the normal charge polarity of the toner. By this, the toner image formed with toner having the negative polarity on the photosensitive drum 11 is primarily transferred onto the intermediary transfer belt 6. To the primary transfer power source 75, a voltage detecting sensor 75a (FIG. 2) as a voltage detecting means (voltage detecting portion) which detects an output voltage thereof and a current detecting sensor 75b (FIG. 2) as a current detecting means (current detecting portion) which detects an output current thereof are connected. In this embodiment, for example, a primary transfer voltage of about 1 to 2 kV is applied to the primary transfer roller 15 (as regards a numerical range, "1 to 2 kV" shows a range including 1 kV and 2 kV, and the same applies hereinafter). In addition, in this embodiment, the primary transfer voltage is subjected to constant-voltage control. In this embodiment, the primary transfer power sources 75y, 75m, 75c and 75k are provided independently of the primary transfer rollers 15y, 15m, 15c and 15k, respectively. Further, in this embodiment, the primary transfer voltages applied to the primary transfer rollers 15y, 15m, 15c and 15k can be individually controlled.

Here, in this embodiment, the primary transfer roller 15 has a core metal and an elastic layer of ion conductive foam rubber (NBR rubber) formed at a periphery of the core metal. An outer diameter of the primary transfer roller 15 is, for example, 15 to 20 mm. In addition, as the primary transfer roller 15, a roller having an electric resistance value of 1x105 to 1x108 Ω (measured at N/N (23°C, 50 %RH), 2 kV applied) can be preferably used.

Further, in this embodiment, the intermediary transfer belt 6 is an endless belt having a two-layer structure including a base layer, and a surface layer in the order named from the inner peripheral surface side toward the outer peripheral surface side. As the material constituting the base layer, a resin such as polyimide or polycarbonate, in which an appropriate amount of carbon black is contained as an antistatic agent can be suitably used. A thickness of the base layer is, for example, 0.05 to 0.15 mm. As a material constituting the surface layer, a resin such as chloroprene rubber (CR) to which electroconductivity is imparted by carbon black can be suitably used. A thickness of the surface layer is, for example, 0.200 to 0.300 mm. In this embodiment, the intermediary transfer belt 6 has a volume resistivity of 5x108 to 1x1014 Ω.cm (23°C, 50 %RH). Incidentally, in this embodiment, the two-layer structure was employed in the intermediary transfer belt 6, but a single-layer structure of a material corresponding to the material of the above-described base layer may also be employed. Further, the surface layer may also be formed as a resin-coated layer, of about 0.002 to 0.01 mm in thickness, containing a resin material such as a fluorine-containing resin. Further, the intermediary transfer belt 6 may have a multi-layer structure of three or more layers.

On the outer peripheral surface side of the intermediary transfer belt 6, the outer secondary transfer roller 25 which is a roller-type secondary transfer member as a secondary transfer means is provided. The outer secondary transfer roller 25 as the secondary transfer member constitutes the secondary transfer device 26 in cooperation with the inner secondary transfer roller 23 as an opposing member (opposing electrode). The outer secondary transfer roller 25 is pressed toward the inner secondary transfer roller 23, and contacts the inner secondary transfer roller 23 by way of the intermediary transfer belt 6 and forms a secondary transfer portion (secondary transfer nip) N2 which is a contact portion between the intermediary transfer belt 6 and the outer secondary transfer roller 25. The toner image formed on the intermediary transfer belt 6 is transferred (secondarily transferred) onto the recording material S, nipped and fed by the intermediary transfer belt 6 and the outer secondary transfer roller 25, by the action of the secondary transfer device 26 in the secondary transfer portion N2. To the outer secondary transfer roller 25, a secondary transfer power source 76 (FIG. 2) as a secondary transfer voltage applying means (secondary transfer voltage applying portion) is connected. During the secondary transfer, the secondary transfer power source 76 applies a secondary transfer voltage (secondary transfer bias), which is a DC voltage having an opposite polarity (positive polarity in this embodiment) to the normal charge polarity of the toner to the outer secondary transfer roller 25. By this, the toner image formed with toner having the negative polarity on the intermediary transfer belt 6 is secondarily transferred onto the recording material S. To the secondary transfer power source 76, a voltage detecting sensor 76a (FIG. 2) as a voltage detecting means (voltage detecting portion) for detecting the output voltage thereof and a current detecting sensor 76b (FIG. 2) as a current detecting means (current detecting portion) for detecting the output current thereof are connected. Further, the core metal of the inner secondary transfer roller 23 is connected to the ground potential. In this embodiment, for example, a secondary transfer voltage of about 1 to 6.5 kV is applied to the outer secondary transfer roller 25, and a secondary transfer current of about 15 to 100 μA is caused to flow through the secondary transfer portion N2, so that the toner image on the intermediary transfer belt 6 is secondarily transferred onto the recording material S. In this embodiment, the secondary transfer voltage is subjected to constant-voltage control. Incidentally, a constitution in which to the inner secondary transfer roller 23, as the secondary transfer member, the secondary transfer voltage which is the DC voltage of the same polarity as the normal charge polarity of the toner is applied from the secondary transfer power source 76, so that the outer secondary transfer roller 25 as the opposing member is connected to the ground potential may also be employed.

The recording material S is fed from the feeding portion 4 toward the secondary transfer portion N2 in parallel to the forming operation of the toner image onto the intermediary transfer belt 6. The recording material S is accommodated in a cassette 41 as a recording material accommodating portion of the feeding portion 4. The recording material S accommodated in the cassette 41 is separated and fed one by one from the cassette 41 by a feeding roller 42 or the like. This recording material S is conveyed by a conveying roller 43 or the like as a conveying member of the feeding portion 4 to a registration roller pair 19 as a conveying member provided in a conveying passage 44 of the recording material S. Then, this recording material S is conveyed to the secondary transfer portion N2 by being timed to the toner image on the intermediary transfer belt 6 by the registration roller pair 19. Incidentally, in FIG. 1, only one cassette 41 is illustrated, but the image forming apparatus 1 may also include a plurality of cassettes 41. Further, the feeding portion 4 may be capable of feeding the recording material S also from a recording material accommodating portion (recording material mounting portion) other than the cassette 41, such as a manual feeding tray or the like.

Here, in this embodiment, the outer secondary transfer roller 25 includes a core metal and an elastic layer of an ion conductive foam rubber (NBR rubber) formed around the core metal. An outer diameter of the outer secondary transfer roller 25 is, for example, 20 to 25 mm. In addition, as the outer secondary transfer roller 25, a roller having an electric resistance value of 1x105 to 1x108 Ω (measured at N/N (23°C, 50 %RH), 2 kV applied) can be preferably used.

The recording material S onto which the toner image was transferred is fed to a fixing device 27 as a fixing means. The fixing device 27 includes a fixing roller 27a and a pressing roller 27b. The fixing roller 27a includes therein a heater as a heating means. The pressing roller 27b is press-contacted to the fixing roller 27a and thus forms a fixing portion (fixing nip). The fixing device 27 causes the recording material S carrying the unfixed toner image to be heated and pressed by nipping and feeding the recording material S between the fixing roller 27a and the pressing roller 27b, and thus causes the toner image to be fixed (melted, sticked) on the recording material S. Incidentally, the temperature of the fixing roller 27a (fixing temperature) is detected by a fixing temperature sensor 77 (FIG. 2). The recording material S on which the toner image was fixed is fed by a discharging roller pair 51 or the like, and is discharged (outputted) through a discharge opening (not shown), onto a discharge tray 52 provided outside an apparatus main assembly 1a of the image forming apparatus 1.

The surface of the photosensitive drum 11 after the primary transfer is electrically discharged by the pre-exposure device 16. In addition, toner remaining on the photosensitive drum 11 without being transferred onto the intermediary transfer belt 6 during the primary transfer (primary transfer residual toner) is removed from the surface of the photosensitive drum 11 by the drum cleaning device 17 and is collected. In this embodiment, the drum cleaning device 17 scrapes off the primary transfer residual toner from the surface of the rotating photosensitive drum 11 by a cleaning blade as a cleaning member, and collects the primary transfer residual toner in a collecting container (not shown). The cleaning blade is a plate-like member contacting the photosensitive drum 11 with a predetermined pressing force. The cleaning blade contacts the surface of the photosensitive drum 11 in a counter direction to the rotational direction of the photosensitive drum 11 so that a leading end thereof on a free end portion side faces the upstream side of the rotational direction of the photosensitive drum 11. Further, a deposited matter such as toner remaining on the intermediary transfer belt 6 without being transferred onto the recording material S during the secondary transfer (secondary transfer residual toner) or the like is removed and collected from the surface of the intermediary transfer belt 6 by a belt cleaning device 24 as an intermediary transfer member cleaning means.

Incidentally, the image forming unit 10 may constitute a cartridge (process cartridge) integrally detachably mountable to the apparatus main assembly 1a of the image forming apparatus 1. Further, in this embodiment, the intermediary transfer unit 20 is constituted by the intermediary transfer belt 6, the stretching rollers for the intermediary transfer belt 6, the respective primary transfer rollers 15, the belt cleaning device 24, and potential regulating members 8 and the like described later. The intermediary transfer unit 20 may be integrally detachably mountable to the apparatus main assembly 1a.

### 2. Control constitution

Next, a constitution of a control system of the image forming apparatus 1 of this embodiment will be described. FIG. 2 is a block diagram showing a schematic constitution of the control system of the image forming apparatus 1 of this embodiment.

The image forming apparatus 1 is provided with the controller 3 (control circuit) as a control means. The controller 3 is constituted by including a CPU 31 as a calculating means, a ROM 32 as a storing means, a RAM 33 as a storing means, and an input/output circuit (I/F) (not shown) for inputting/outputting signals between itself and the external device. The ROM 32 stores programs or the like for controlling the respective portions of the image forming apparatus 1. The RAM 33 temporarily stores data on the control. The CPU 31 is a microprocessor which controls the entire image forming apparatus 1 and is a main part of a system controller. The CPU 31 is connected to the respective portions such as the feeding portion 4, the image forming portion 2, the discharge portion 5, and the like, and not only exchanges signals with these portions, but also controls the operation of each of these portions. The ROM 32 stores an image formation control sequence for forming the image on the recording material S.

To the controller 3, the charging power source 73, the developing power source 74, the primary transfer power source 75, the secondary transfer power source 76, and a potential regulating power source 80 described hereinafter, which are controlled by signals from the controller 3, respectively, are connected. Incidentally, although omitted from illustration, in this embodiment, each of the charging power source 73, the developing power source 74, the primary transfer power source 75, and the potential regulating power source 80 is provided independently of the associated image forming unit 10. In addition, to the controller 3, the temperature sensor 71, the humidity sensor 72, the voltage detecting sensor 75a and the current detecting sensor 75b of the primary transfer power source 75, the voltage detecting sensor 76a and the current detecting sensor 76b of the secondary transfer power source 76, and the fixing temperature sensor 77, and the like are connected. A signal (information) indicating a detection result of the associated sensor is inputted to the controller 3. Further, to the controller 3, an operating portion 70 is connected. Then operating portion 70 includes an input portion constituted by an operation button (key) or the like as an input means, and a display portion 70a constituted by a liquid crystal panel (display) or the like as display means. Incidentally, in this embodiment, the display portion 70a is constituted as a touch panel, and also has a function as the input means. An operator such as a user or a service person operates the operating portion 70 and thus can cause the image forming apparatus 1 to execute a job (a series of operations for forming and outputting an image on a single recording material S or images on a plurality of recording materials S by a single start instruction). The controller 3 receives the signal from the operating portion 70 and operates various devices of the image forming apparatus 1. In addition, the image forming apparatus 1 can also execute the job depending on the signal, for example, from the external device such as the personal computer, not from the operating portion 70.

### 3. Summary of problem and solution

Next, the problem in this embodiment will be described. Incidentally, for convenience, unless otherwise mentioned, a magnitude (high/low) of a voltage and a potential refers to a magnitude (high/low) in the case where values thereof are compared with each other in terms of an absolute value. Further, as regards arrangements of the primary transfer portion N1, the photosensitive drum 11, the primary transfer roller 15, and the potential regulating member 8 described later, and the like, unless otherwise mentioned, upstream and downstream refer to upstream and downstream with respect to the feeding direction (process progression direction, movement direction) of the intermediary transfer belt 6.

As described above, in the image forming apparatus 1 of the intermediary transfer type, it is difficult to uniformly transfer the toner image on, for example, embossed paper with surface unevenness. Incidentally, the embossed paper is paper (fancy paper) provided with an uneven pattern by using a method such as swelling or stamping on the surface of the paper. Particularly, transfer of the toner image onto a recessed portion of the embossed paper requires a relatively large transfer electric field because a gap is formed between the intermediary transfer belt 6 and the embossed paper in the secondary transfer portion N2, and thus is liable to become difficult. Further, when a secondary transfer electric field is made large for improving a transfer property of the toner image onto the recessed portion of the embossed paper, in the case where the transfer electric field becomes excessively large at a portion other than the recessed portion, there is a possibility that improper transfer such that the toner is not partially transferred onto a half-tone image occurs.

The toner on the intermediary transfer belt 6 is subjected to electric discharge between the intermediary transfer belt 6 and the photosensitive drum 11 on a side downstream of the primary transfer portion N1 and thus a charge amount of the toner increases. Specifically, the toner is subjected to the electric discharge and thus there is a tendency that an average of the charge amount of the toner is increased while a toner charge amount distribution becomes broader than a toner charge amount distribution during the development. In addition, the charge amount increases as described above, and therefore, a mirror force between the toner and the intermediary transfer belt 6 increases and a transfer electric field necessary to transfer the toner onto the recording material S in the secondary transfer portion N2 becomes large, and thus it becomes further difficult to transfer the toner image onto the recessed portion of the embossed paper.

A transfer property of the toner image onto the recording material S, such as the embossed paper, onto which transfer of the toner image is relatively difficult can be improved by suppressing the above-described electric discharge and the increase in charge amount of the toner on the intermediary transfer belt 6. In order to suppress the above-described electric discharge, it is effective that a potential difference between the photosensitive drum 11 and the intermediary transfer belt 6 after the toner image passes through the primary transfer portion N1 is made small. Further, for that purpose, it is effective that a potential regulating member 8 which is an electrode member is provided on an inner peripheral surface (back surface) side of the intermediary transfer belt 6 in a position downstream of the primary transfer portion N1 and that a voltage of the same polarity as the charge polarity of the photosensitive drum 11 is applied to the potential regulating member 8. Particularly, the above-described electric discharge can be more effectively suppressed by disposing the potential regulating member 8 in contact with the inner peripheral surface of the intermediary transfer belt 6 and by applying the voltage of the same polarity as the charge polarity of the photosensitive drum 11 to the potential regulating member 8.

Further, the above-described electric discharge occurs in a range of about 0.3 to 1.5 mm from the primary transfer portion N1 toward a downstream side in many cases. On the other hand, it would be considered that by applying the voltage of the same polarity as the charge polarity of the photosensitive drum 11 to the potential regulating member 8, the above-described electric discharge can be suppressed by the action of an electric field formed in a space between the photosensitive drum 11 and the potential regulating member 8. Further, the above-described electric discharge suppressing effect is larger in the case where the potential regulating member 8 is surface-contacted to the intermediary transfer belt 6 with a width with respect to the feeding direction of the intermediary transfer belt 6 than in the case where the potential regulating member 8 is point (line)-contacted to the intermediary transfer belt 6 with respect to the feeding direction of the intermediary transfer belt 6. Further, by bringing the potential regulating member 8 into surface contact with the intermediary transfer belt 6, a contact state between the intermediary transfer belt 6 and the potential regulating member 8 can be stabilized. This would be considered that an electrostatic adsorption force acts between the intermediary transfer belt 6 and the potential regulating member 8. Accordingly, it is more preferable that the potential regulating member 8 is surface-contacted to the intermediary transfer belt 6.

Here, surface contact (contact at the surface) does not mean only the case where a whole region of a surface (surface opposing the inner peripheral surface of the intermediary transfer belt 6 and provided with a contact region contactable to the inner peripheral surface) of the potential regulating member 8 contacting the inner peripheral surface of the intermediary transfer belt 6 continuously closely contacts the inner peripheral surface of the intermediary transfer belt 6. The surface contact (contact at the surface) also includes, as specifically described later, the case where a contact area is reduced by an uneven surface shape. That is, the surface contact (contact at the surface) means that the contact does not include the case where the potential regulating member 6 is contacted to the intermediary transfer belt 6 only in a line shape with respect to a direction crossing the feeding direction of the intermediary transfer belt 6 in a range narrower than a contact width (about 5 to 50 mm) as described specifically hereinafter. Accordingly, the surface contact (contact at the surface) includes, for example, not only the case where a substantially entire region of the potential regulating member 8 is continuously and closely contacted to the intermediary transfer belt 6 in a region of the contact width described specifically hereinafter but also the case where a region (contact region) which is formed by providing an uneven shape described later in the region of the contact width and which is contactable to the inner peripheral surface of the intermediary transfer belt 6 is substantially uniformly distributed. Further, as described later, the surface contact includes the case where many contact points are distributed in the above-described region of the contact width by providing a nonwoven fabric or the like on a contact surface 83 having the uneven shape.

Further, in order to effectively suppress the electrical discharge on the side downstream of the primary transfer portion N1, it can be said that it is desirable that the potential regulating member 8 is brought near to the primary transfer portion N1 and that a bias, of the same polarity as the charge polarity of the photosensitive drum 11, applied to the potential regulating member 8 is made high.

That is, it is desired that in a state in which the potential regulating member 8 is surface-contacted to the inner peripheral surface of the intermediary transfer belt 6, the potential regulating member 8 is brought near to the primary transfer portion N1 as can as possible and to the potential regulating member 8, a relatively high bias of the same polarity as the charge polarity of the photosensitive drum 11 is applied.

Here, as described above, by applying the bias to the potential regulating member 8, the intermediary transfer belt 6 is electrostatically adsorbed by the potential regulating member 8. Further, there is a tendency that with a higher bias applied to the potential regulating member 8, the electrostatic adsorption force between the intermediary transfer belt 6 and the potential regulating member 8 increases and a sliding property between the intermediary transfer belt 6 and the potential regulating member 8 lowers, and a traveling property of the intermediary transfer belt 6 becomes unstable. That is, when electrostatic adsorption generating between the potential regulating member 8 and the intermediary transfer belt 6 during an image forming operation (during traveling of the intermediary transfer belt 6) is strong, the traveling property of the intermediary transfer belt 6 lowers in some cases. Then, as shown in FIG. 13, with a region, where the potential regulating member 8 and the intermediary transfer belt 6 are electrostatically adsorbed, as a starting point, the intermediary transfer belt 6 is loosened on a side upstream of the primary transfer portion N1 in some cases (a chain double-dashed line in FIG. 13). As a result, for example, there is a possibility that gap electric discharge generates between the photosensitive drum 11 and the intermediary transfer belt 6, so that a polarity of the toner which is a part of the toner image is reversed and the toner is not transferred onto the intermediary transfer belt 6, and thus "image white void" occurs.

On the other hand, in this embodiment, a surface shape of the surface (surface opposing the inner peripheral surface of the intermediary transfer belt 6 provided with the contact region contactable to the inner peripheral surface) of the potential regulating member 8 contacting the inner peripheral surface of the intermediary transfer belt 6 is made a surface shape of an uneven type. By this, it was formed that a lowering in traveling property of the intermediary transfer belt 6 can be suppressed by suppressing the electrostatic adsorption force between the potential regulating member 8 and the intermediary transfer belt 6 through reduction in contact area of the potential regulating member 8 with the inner peripheral surface of the intermediary transfer belt 6.

### 4. Potential regulating member

Next, a constitution of the potential regulating member 8 in this embodiment will be described.

As shown in FIG. 1, the image forming apparatus 1 of this embodiment, on sides downstream of the primary transfer portions N1y, N1m, N1c, and N1k, the potential regulating members 8y, 8m, 8c, and 8k which are electrode members are provided, respectively, in contact with the inner peripheral surface of the intermediary transfer belt 6. In this embodiment, the potential regulating members 8y, 8m, 8c, and 8k provided in the primary transfer portions N1y, N1m, N1c, and N1k have the substantially same constitution.

A shape of the potential regulating member 8 in this embodiment will be described. Part (a) of FIG. 3 is a schematic sectional view (cross section substantially perpendicular to a rotational axis direction of the photosensitive drum 11) of the potential regulating member 8 in this embodiment, and part (b) of FIG. 3 is a schematic perspective view of the potential regulating member 8.

In this embodiment, the potential regulating member 8 includes a planar first portion 81 provided along a widthwise direction (direction substantially perpendicular to the feeding direction, direction substantially parallel to the rotational axis direction of the photosensitive drum 11) of the intermediary transfer belt 6. Further, in this embodiment, the potential regulating member 8 includes a planar second portion 82 provided along the widthwise direction of the intermediary transfer belt 6 and extending in a direction crossing (in this embodiment, substantially perpendicular to) a flat surface of the first portion 81. In this embodiment, a surface of the first portion 81 of the potential regulating member 8 constitutes the contact surface 83 which is the surface (the surface opposing the inner peripheral surface of the intermediary transfer belt 6 and provided with the contact area contactable to the inner peripheral surface) contacting the inner peripheral surface of the intermediary transfer belt 6. In this embodiment, the contact surface 83 of the potential regulating member 8 is a flat surface. However, as specifically described later, in this embodiment, the contact surface 83 of the potential regulating member 8 is provided with an uneven shape. That is, in this embodiment, the first portion 81 constituting the contact surface 83 of the potential regulating member 8 is a flat plate. Thus, in this embodiment, the potential regulating member 8 is constituted by a substantially L-shaped member in cross section substantially perpendicular to the rotational axis direction of the photosensitive drum 11.

Here, in the cross section substantially perpendicular to the rotational axis direction of the photosensitive drum 11, an upstream-side end portion of the contact surface 83 is defined as "A (or upstream end A)", and a downstream-side end portion of the contact surface 83 is defined as "B (or downstream end B)". In this embodiment, the upstream end A of the contact surface 83 corresponds to an upstream-side end portion of the potential regulating member 8, and the downstream end B of the contact surface 83 corresponds to a downstream-side end portion of the potential regulating member 8. As described above, by the action of the electric field formed in the space between the photosensitive drum 11 and the potential regulating member 8, in order to more effectively suppress the electric discharge between the intermediary transfer belt 6 and the photosensitive drum 11, the potential regulating member 8 may preferably be surface-contacted to the intermediary transfer belt 6. From this viewpoint, a length of a line segment AB (between A and B), i.e., a "contact width" which is a length of the contact surface 83 in the feeding direction of the intermediary transfer belt 6 may preferably be 5 mm or more. With a longer length of the line segment AB, the above-described effect of suppressing the electric field becomes larger, but it would be considered that when the length becomes excessively long, stable contact of the potential regulating member 8 with the intermediary transfer belt 6 becomes difficult by the influence of (component) part accuracy or the like. The length of the line segment AB is sufficient in many cases when the length is 50 mm or less, and typically is 30 mm or less. That is, the length of the line segment AB may suitably be about 5 to 50 mm, typically about 5 to 30 mm. From another viewpoint, it can be said that the length of the line segment AB is enough to be not more than a half of a center distance between adjacent photosensitive drums 11 in a cross section substantially perpendicular to the rotational axis direction of the photosensitive drum 11 in many cases. In this embodiment, the potential regulating member 8 which is 25 mm in length of the line segment AB is used. Incidentally, in this embodiment, the center distance between the photosensitive drums 11 in the cross section substantially perpendicular to the rotational axis direction of the photosensitive drum 11 is about 100 mm.

To the potential regulating member 8, the potential regulating power source 80 as a potential regulating voltage applying means (potential regulating voltage applying portion) is connected. In this embodiment, to the second portion 82 of the potential regulating member 8, the potential regulating power source 80 is connected. At least at the time of the primary transfer during the image forming operation, to the potential regulating member 8, a potential regulating voltage (potential regulating bias) which is a DC voltage of the same polarity as the charge polarity of the photosensitive drum 11 is applied by the potential regulating power source 80. The time of the primary transfer is specifically a period in which the primary transfer voltage is applied, more specifically, a period in which an image region (region onto which the toner image is capable of being transferred) on the intermediary transfer belt 6 passes through the primary transfer portion N1. By this, it is possible to suppress the electric discharge between the intermediary transfer belt 6 and the photosensitive drum 11 on a side downstream of the primary transfer portion N1. In this embodiment, the potential regulating voltage is a DC voltage of a negative polarity. Further, in the constitution of this embodiment, the potential regulating voltage may preferably be about -500 to -8000 V, more preferably be about -1000 to -5000 V, typically about -1000 to -3000 V.

The potential regulating member 8 is a member long in the widthwise direction of the intermediary transfer belt 6. A length of the contact surface 83 of the potential regulating member 8 in a longitudinal direction (direction along the widthwise direction of the intermediary transfer belt 6 may preferably be longer than a maximum image width in the widthwise direction of the intermediary transfer belt 6. Incidentally, the maximum image width is a length of an image region of a maximum image capable of being formed by the image forming apparatus 1 with respect to the widthwise direction of the intermediary transfer belt 6. In this embodiment, the length of the contact surface 83 of the potential regulating member 8 in the longitudinal direction is longer than the above-described maximum image width and a width of a portion in which the primary transfer roller 15 contacts the intermediary transfer belt 6 with respect to the widthwise direction of the intermediary transfer belt 6. That is, in this embodiment, each of a range of the maximum image width and a range of the width of the portion in which the primary transfer roller 15 contacts the intermediary transfer belt 6 with respect to the widthwise direction of the intermediary transfer belt 6 falls inside a range of the length of the contact surface 83 of the potential regulating member 8 in the longitudinal direction. By this, irrespective of a length of the toner image, transferred onto the intermediary transfer belt 6, with respect to the widthwise direction of the intermediary transfer belt 6, it is possible to obtain an effect of suppressing an increase in charge amount of the toner on the intermediary transfer belt 6 by suppressing the above-described electric charge. On the other hand, in this embodiment, the length of the potential regulating member 8 in the longitudinal direction is shorter than the width of the intermediary transfer belt 6. That is, in this embodiment, the range of the length of the potential regulating member 8 in the longitudinal direction falls inside the range of the width of the intermediary transfer belt 6. By this, it is possible to suppress the electric discharge, between the potential regulating member 8 and a peripheral member or the like of the intermediary transfer belt 6, capable of occurring in the case where an end portion of the potential regulating member 8 with respect to the longitudinal direction protrudes than an end portion of the intermediary transfer belt 6 with respect to the widthwise direction is. As a result, it is possible to reduce a possibility that the effect of suppressing the electrical discharge between the intermediary transfer belt 6 and the photosensitive drum 11 by the potential regulating member 8 becomes small.

The potential regulating member 8 can be constituted only by, for example, a single material having electroconductivity. In this embodiment, the potential regulating member 8 is constituted substantially only by metal having electroconductivity, such as SUS (stainless steel). Specifically, in this embodiment, the potential regulating member 8 is constituted by forming the first portion 81 and the second portion 82 by subjecting a plate material made of metal (metal plate) such as SUS to bending. A thickness of the metal plate used for the potential regulating member 8 may be, for example, about 0.5 to 5 mm, typically is about 1 to 3 mm. By thus subjecting the metal plate to the bending, strength of the potential regulating member 8 can be increased. In this embodiment, each of the first portion 81 and the second portion 82 of the potential regulating member 8 is not substantially deformed in a use state of the image forming apparatus 1. However, the present disclosure is not limited to such an embodiment, but the potential regulating member 8 may also be constituted by two or more materials.

Incidentally, the electroconductive material (electroconductor) refers to a material (substance) of which resistivity is about 10-6 Ω.cm or less, typically about 10-8 Ω.m. Further, a non-electroconductive material (insulator) refers to a material (substance) of which resistance value is 108 Ω.m or more, preferably 1010 Ω.m or more. However, the insulator is 1016 Ω.m or less in resistivity.

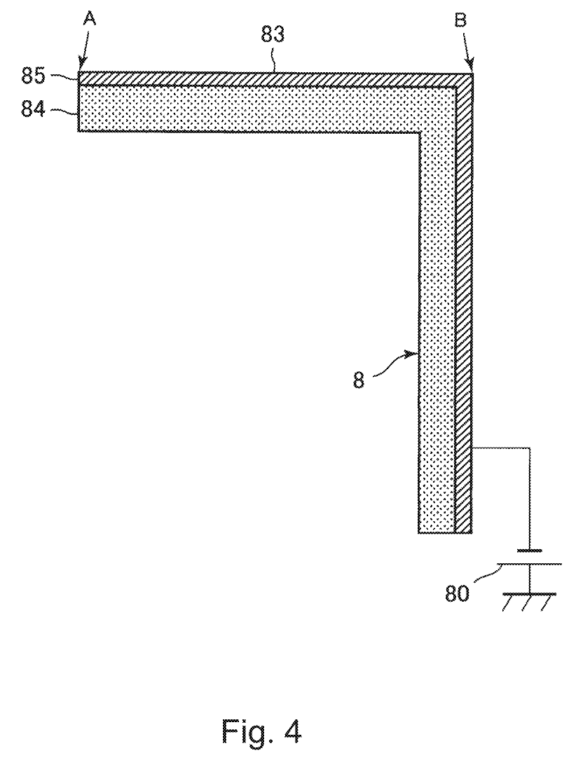

FIG. 4 is a schematic sectional view (cross section substantially perpendicular to the rotational axis direction of the photosensitive drum 11) in another example of the potential regulating member 8. For example, as shown in FIG. 4, a constitution in which a base portion 84 having a shape similar to the shape of the potential regulating member 8 shown in FIG. 3 and a surface layer 85 formed on the base portion 84 are provided can be employed. The contact surface 83 contacting the intermediary transfer belt 6 and the surface layer 85 constituting a connecting portion with the potential regulating power source 80 are formed of an electroconductive material such as metal or an electroconductive resin material.

The surface layer 85 may also have a constitution which is the same constitution as the constitution of the potential regulating member 8 shown in FIG. 3. The base portion 84 may be formed of the electroconductive material, but may also be formed of a non-electroconductive (electrically insulative) material, for example, a non-electroconductive resin material. The base portion 84 and the surface layer 85 can be fixed by an arbitrary fixing means such as bonding with an adhesive or welding.

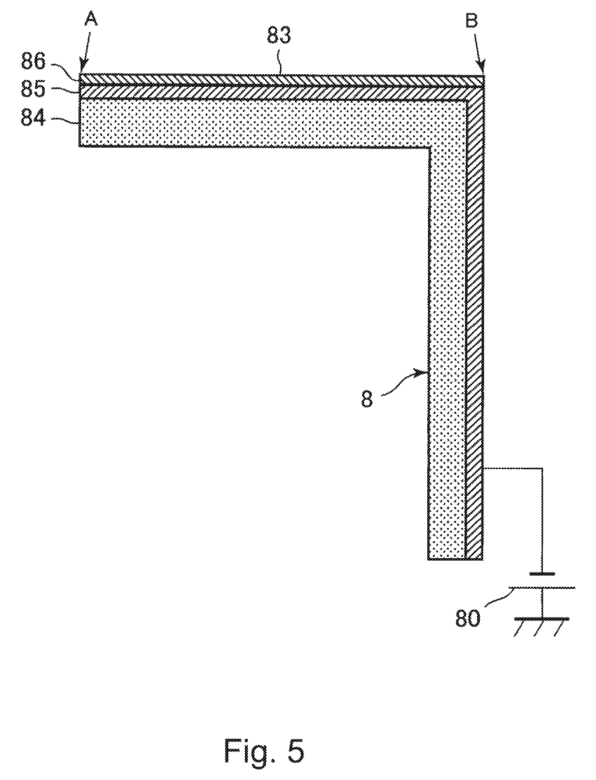

Further, FIG. 5 is a schematic sectional view (cross section substantially perpendicular to the rotational axis direction of the photosensitive drum 11) in still another example of the potential regulating member 8. For example, as shown in FIG. 5, the contact surface 83 of the potential regulating member 8 contacting the intermediary transfer belt 6 may also be formed of an electroconductive nonwoven fabric 86. Incidentally, in an example shown in FIG. 5, the electroconductive nonwoven fabric 86 is provided on the contact surface 83 of the potential regulating member 8 having the constitution shown in FIG. 4, but the electroconductive nonwoven fabric 86 may also be provided on the contact surface 83 of the potential regulating member 8 having the constitution shown in FIG. 3. That is, the potential regulating member 8 may be formed by using other materials for the base portion to which the voltage is applied and the surface layer contacting the inner peripheral surface of the intermediary transfer belt 6. The electroconductive nonwoven fabric 86 can be fixed by an arbitrary fixing means such as an electroconductive adhesive. Further, instead of the nonwoven fabric 86, a felt, a pile fabric (cut pile fabric (velvet, brush) or loop pile fabric (toweling)) which are constituted using electroconductive fibers, or a sponge (elastic foam member) constituted using an electroconductive rubber material may also be used. Thus, the contact surface 83 of the potential regulating member 8 contacting the intermediary transfer belt 6 is constituted by a flexible material or an elastic material, so that it is possible to reduce a possibility of an occurrence of scars on an inner peripheral surface of the intermediary transfer belt 6 caused by friction (slide) between the inner peripheral surface of the intermediary transfer belt 6 and the potential regulating member 8.

### 5. Arrangement of potential regulating member

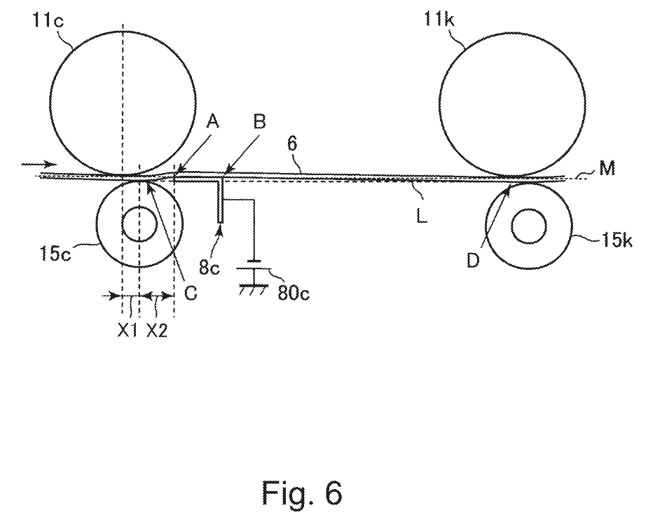

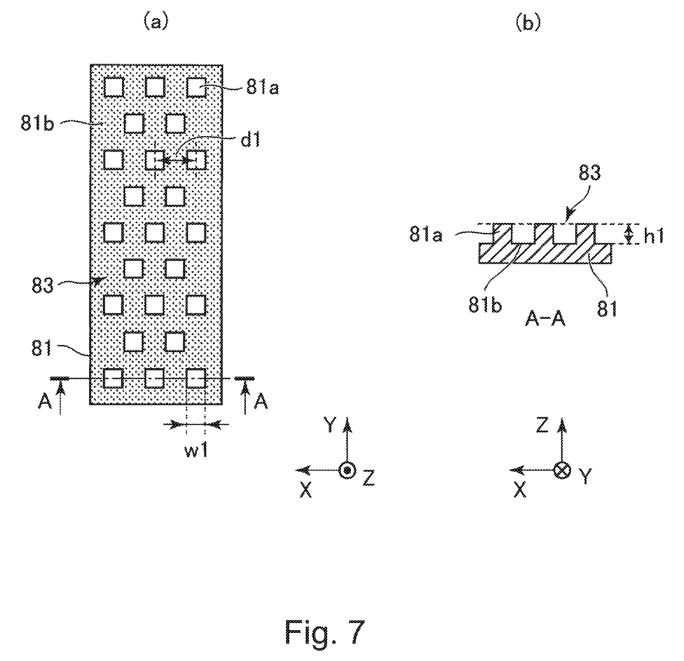

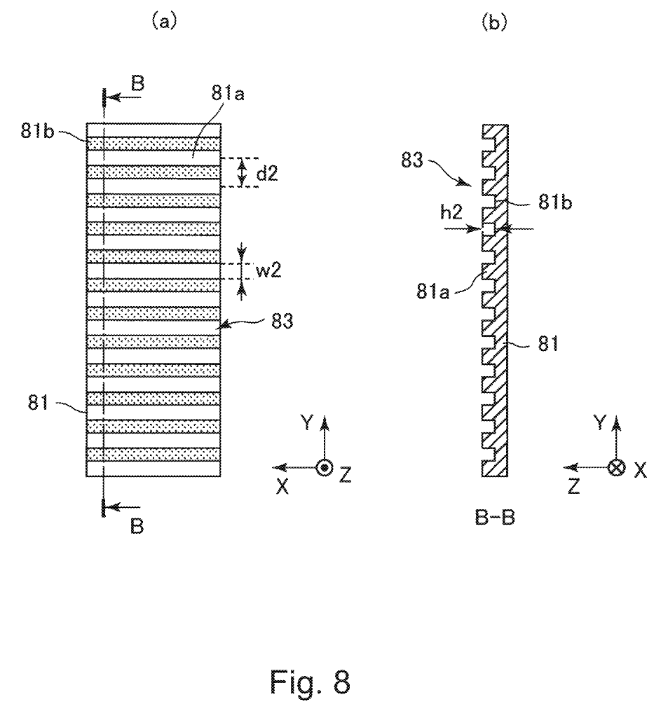

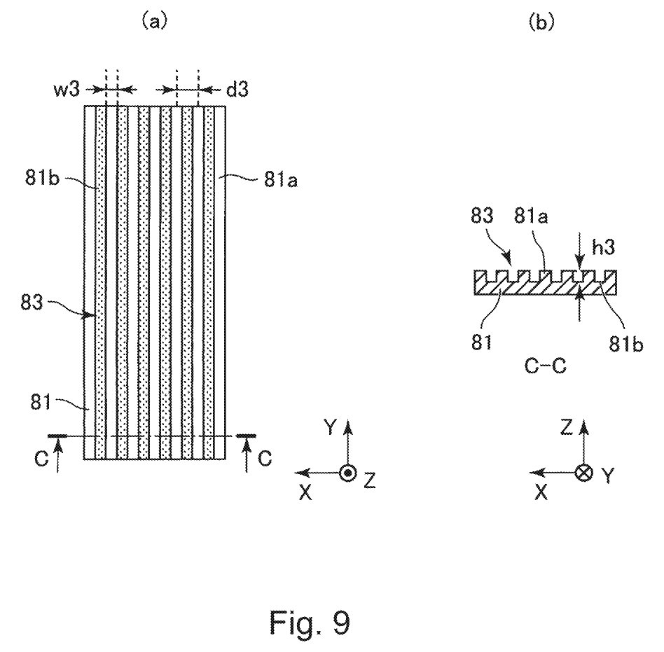

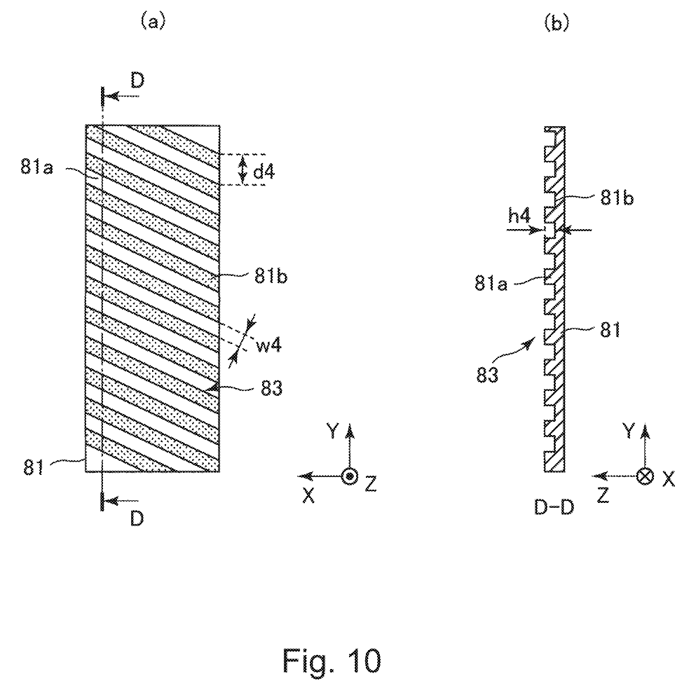

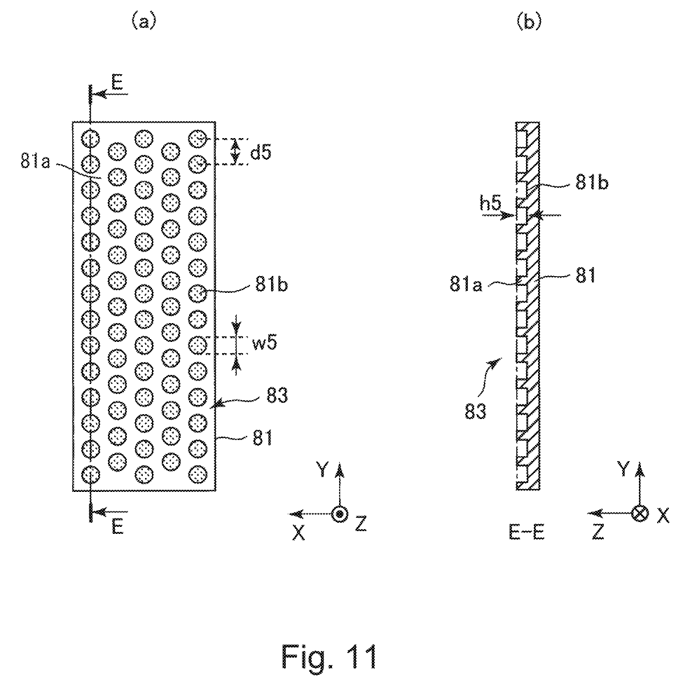

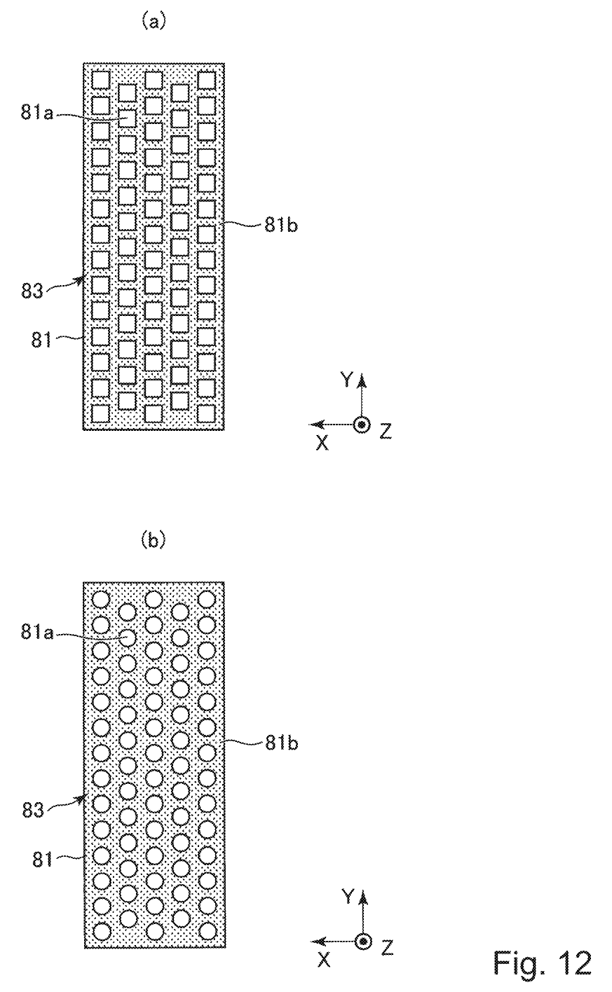

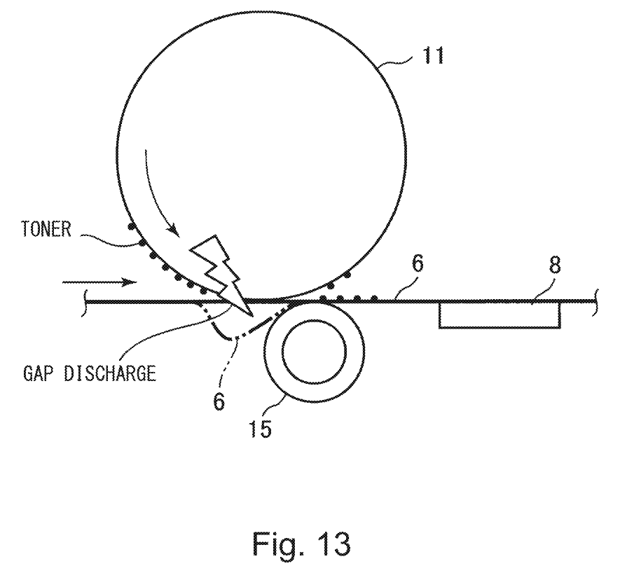

Next, an arrangement of the potential regulating member 8 in this embodiment will be described. In this embodiment, the arrangement of the potential regulating member 8 provided for each of the primary transfer portions N1y, N1m, N1c, and N1k is substantially the same. FIG. 6 is a schematic sectional view (cross section substantially perpendicular to the rotational axis direction of the photosensitive drum 11) for illustrating the arrangement of the potential regulating member 8 provided between two primary transfer portions N1 adjacent to each other in the feeding direction of the intermediary transfer belt 6. In FIG. 6, as an example, a potential regulating member 8c provided between the primary transfer portions N1c for cyan and N1k for black is shown.

In this embodiment, an outer diameter of the photosensitive drum 11 is 30 mm, an outer diameter of the primary transfer roller 15 is 18 mm, and a thickness of the intermediary transfer belt 6 is 0.350 mm. Further, in this embodiment, the primary transfer roller 15 is offset toward a downstream side relative to the photosensitive drum 11. In this embodiment, an offset amount X1 is 3 mm. Incidentally, the offset amount X1 is a distance between a rotation center of the photosensitive drum 11 and a rotation center of an associated primary transfer roller 15 in a direction along (substantially parallel to) a common tangential line on a side where a plurality of photosensitive drums 11 contact the intermediary transfer belt 6 in a cross section substantially perpendicular to the rotational axis direction of the photosensitive drum 11. Further, the primary transfer roller 15 may be disposed without being offset relative to the photosensitive drum 11 and may also be disposed so as to be offset toward an upstream side relative to the photosensitive drum 11.

Here, in order to illustrate the arrangement of the potential regulating member 8, the case where the potential regulating member 8 is removed is assumed. In the cross section substantially perpendicular to the rotational axis direction of the photosensitive drum 11, a rectilinear line along which a stretching surface of the intermediary transfer belt 6 on an inner peripheral surface side in a portion downstream of the primary transfer portion N1 passes in the case where there is no potential regulating member 8 is defined as a rectilinear line L. Incidentally, specifically, this rectilinear line L corresponds to the stretching surface in a state in which only the potential regulating member 8 is substantially removed from the constitution of the image forming apparatus 1 in a state during the image forming operation (however, the photosensitive drum 11 and the intermediary transfer belt 6 are at rest). That is, the rectilinear line L corresponds to the above-described stretching surface in a state in which a stretching state of the intermediary transfer belt 6 is an image formable stretching state (such that the toner image is capable of being primarily transferred from the photosensitive drum 11 onto the intermediary transfer belt 6) and in which the intermediary transfer belt 6 is at rest (stationary). Further, on the rectilinear line L, a portion where the inner peripheral surface of the intermediary transfer belt 6 is separated from a closest stretching member on an upstream side of the potential regulating member 8 is defined as "C (or upstream stretching portion C)", and a portion where the inner peripheral surface of the intermediary transfer belt 6 is separated from a closest stretching member on a downstream side of the potential regulating member 8 is defined as "D (or downstream stretching portion D)". Incidentally, in FIG. 6, the rectilinear line L is schematically shown substantially horizontally, but in the case where the surface of the primary transfer roller 15 is raised toward the photosensitive drum 11 side by deformation or the like of the elastic layer of the primary transfer roller 15, the rectilinear line L may be inclined downward toward the downstream side in FIG. 6.

In this embodiment, the closest stretching member on the upstream side of the potential regulating member 8 is the primary transfer roller 15, and a position on the inner peripheral surface of the intermediary transfer belt 6 at a portion where the intermediary transfer belt 6 is separated from the primary transfer roller 15 is the upstream stretching portion C. However, the closest stretching member on the upstream side of the potential regulating member 8 is not limited to the primary transfer roller 15. For example, in the case where the primary transfer roller 15 is offset and disposed on an upstream side relative to the photosensitive drum 11, a position on the inner peripheral surface of the intermediary transfer belt 6 at a portion corresponding to a portion where the intermediary transfer belt 6 is separated from the photosensitive drum 11 is the upstream stretching portion C.

Further, in this embodiment, the closest stretching member on the downstream side of the potential regulating member 8 is the photosensitive drums 11m, 11c, and 11k disposed adjacent to the potential regulating member 8 on the downstream side of the potential regulating member 8 for the primary transfer portions N1y, N1m, and N1c, respectively, for yellow, magenta, and cyan. Further, a position on the inner peripheral surface of the intermediary transfer belt 6 at a portion corresponding to a portion where the intermediary transfer belt 6 is separated from an associated one of the photosensitive drums 11m, 11c, and 11k is the downstream stretching portion D. However, the closest stretching member on the downstream side of the potential regulating member 8 is not limited to the photosensitive drum 11. For example, in the case where the primary transfer roller 15 is offset and disposed on the upstream side relative to the photosensitive drum 11, a position on the inner peripheral surface of the intermediary transfer belt 6 at a portion where the intermediary transfer belt 6 is separated from the primary transfer roller 15 is the downstream stretching portion D. Further, in this embodiment, for the most downstream primary transfer portion N1k for black, the closest stretching member on the downstream side thereof is the stretching roller (tension roller in this embodiment) 22. Further, a position on the inner peripheral surface of the intermediary transfer belt 6 at a portion where the intermediary transfer belt 6 is separated from the stretching roller 22 is the downstream stretching portion D.

Further, for each of the primary transfer portions N1, as the closest stretching member on the downstream side of the potential regulating member 8, in the case where there is another stretching roller for regulating an attitude of the intermediary transfer belt 6 during the image forming operation, the rectilinear line L and the downstream stretching portion D are defined on the basis of its stretching roller. Further, also in the case where not the stretching roller, a scraper or a brush is contacted to the inner peripheral surface of the intermediary transfer belt 6 for the purpose of cleaning the inner peripheral surface of the intermediary transfer belt 6 or for the like purpose, the scraper or the brush can be regarded as the closest stretching member on the downstream side of the potential regulating member 8 when the scraper or the brush regulates the attitude of the intermediary transfer belt 6 during the image forming operation. The scraper is constituted by a sheet-like or film-like member in general.

As shown in FIG. 6, the potential regulating member 8 is disposed close to the primary transfer portion N1 on a side downstream of the primary transfer portion N1 so as not to contact the primary transfer roller 15 and the photosensitive drum 11 via the intermediary transfer belt 6. At this time, as the upstream end A is closer to the primary transfer portion N1, the effect of suppressing the electric charge between the intermediary transfer belt 6 and the photosensitive drum 11 by the potential regulating member 8 becomes larger. In this embodiment (FIG. 6), the potential regulating member 8 is disposed in a position downstream of the primary transfer portion N1 so that a distance X2 from the primary transfer roller 15 to the upstream end A becomes about 8 mm. Here, the distance X2 is a distance between the rotation center of the primary transfer roller 15 and the upstream end A in a direction along (substantially parallel to) the common tangential line on a side where the plurality of photosensitive drums 11 contact the intermediary transfer belt 6 in the cross section substantially perpendicular to the rotational axis direction of the photosensitive drum 11.

That is, in this embodiment, the distance from the rotation center of the primary transfer roller 15 to the upstream end A is shorter than a distance (radius) from the rotation center of the primary transfer roller 15 to an outer circumference of the primary transfer roller 15. This distance is not limited thereto, but the above-described distance X2 may preferably be about 1 to 20 mm, typically about 1 to 10 mm.

Further, in this embodiment, the potential regulating member 8 is pressed against the inner peripheral surface of the intermediary transfer belt 6 by a pressing spring 87 constituted by a compression coil spring which is an urging member as an urging means at each of opposite end portions thereof with respect to the longitudinal direction thereof. At this time, the contact portion of the potential regulating member 8 contacting the inner peripheral surface of the intermediary transfer belt 6 is caused to enter the photosensitive drum 11 side relative to the rectilinear line L. By this, even in the case where waving or vibration occurs on the intermediary transfer belt 6 during the image forming operation (during traveling of the intermediary transfer belt 6), the potential regulating member 8 can be more stably contacted to the intermediary transfer belt 6. In this embodiment, a pressing force of the pressing spring 87 is set (adjusted) so that the upstream end A and the downstream end B of the contact surface 83 of the potential regulating member 8 are caused to enter the photosensitive drum 11 side relative to the rectilinear line L by about 0.5 mm. Thus, the contact surface 83 of the potential regulating member 8 is caused to enter the photosensitive drum 11 side relative to the rectilinear line L, whereby even in the case where the warning or the vibration occurs on the intermediary transfer belt 6 during the image forming operation (during the traveling of the intermediary transfer belt 6, the potential regulating member 8 can be more stably surface-contacted to the intermediary transfer belt 6. Although the potential regulating member 8 is not limited thereto, an entering amount of the contact surface 83 of the potential regulating member 8 into the rectilinear line L may preferably be about 0.3 to 5 mm, more preferably about 0.5 to 3 mm, typically about 0.5 to 1.0 mm. When this entering amount is excessively small, there is a possibility that stable contact of the potential regulating member 8 to the intermediary transfer belt 6 becomes difficult. When the entering amount is excessively large, there is a possibility that stable feeding (conveyance) of the intermediary transfer belt 6 becomes difficult and that the electric discharge between the intermediary transfer belt 6 and the photosensitive drum 11 increases.

Here, in the cross section substantially perpendicular to the rotational axis direction of the photosensitive drum 11, a rectilinear line passing through the upstream end A and the downstream end B of the contact surface 83 is defined as a rectilinear line M. At this time, it is preferable that the rectilinear line M is prevented from crossing a line segment CD of the rectilinear line L. By this, in the case where the contact surface 83 of the potential regulating member 8 is a flat surface, the intermediary transfer belt 6 and the potential regulating member 8 can be surface-contacted to each other more reliably. In the case where the rectilinear line M crosses the line segment CD of the rectilinear line L, there is a possibility that only either one of an end portion of the potential regulating member 8 on the upstream end A side and an end portion of the potential regulating member 8 on the downstream end B side can contact the inner peripheral surface of the intermediary transfer belt 6. In this case, there is a possibility that it becomes difficult to improve the electric discharge suppressing effect by the surface contact. Further, in FIG. 6, the potential regulating member 8 is disposed so that the rectilinear line M and the rectilinear line L are substantially parallel to each other, but when the rectilinear line M falls within a range in which the rectilinear line M does not cross the line segment CD of the rectilinear line L, the potential regulating member 8 may be disposed so that the rectilinear line M is inclined relative to the rectilinear line L.

Incidentally, the contact portion of the potential regulating member 8 contacting the inner peripheral surface of the intermediary transfer belt 6 is not limited to the flat surface. For example, the potential regulating member 8 is constituted by a bent plate of which cross section substantially perpendicular to the rotational axis direction of the photosensitive drum 11 is bent in a convexly curved line shape toward the photosensitive drum 11 side, and the contact portion of the potential regulating member 8 contacting the inner peripheral surface of the intermediary transfer belt 6 may also be a curved surface convexly toward the photosensitive drum 11 side. Thus, the contact portion (contact side) of the potential regulating member 8 contacting the inner peripheral surface of the intermediary transfer belt 6 is formed in a curved surface shape, so that stress when the potential regulating member 8 rubs the intermediary transfer belt 6 can be reduced. By using a roller-shaped potential regulating member 8, the contact portion of the potential regulating member 8 contacting the inner peripheral surface of the intermediary transfer belt 6 may also be formed as a curved surface.

Further, in this embodiment, as the recording material S relatively difficult in transfer of the toner image thereon, the embossed paper was cited as an example, but a similar effect can be expected also on a recording material relatively high in electric resistance (high-resistance paper), such as synthetic paper or a resin film, which principally comprises a synthetic resin material.

### 6. Surface shape of potential regulating member

Next, the surface shape of the potential regulating member 8 in this embodiment will be further described.

As described above, in the case where a relatively high bias is applied to the potential regulating member 8 or in the like case, the electrostatic adsorption force between the intermediary transfer belt 6 and the potential regulating member 8 increases, so that the traveling property of the intermediary transfer belt 6 becomes unstable in some instances. As a result, for example, there is a possibility that the gap electric discharge occurs on the side upstream of the primary transfer portion N1 (FIG. 3) and thus the "image white void" occurs.

Incidentally, the bias applied to the potential regulating member 8 can be determined in the following manner, for example. It is desired that the bias applied to the potential regulating member 8 is a bias high in effect of suppressing an increase in charge amount of the toner due to the electric discharge on the side downstream of the primary transfer portion N1. In addition, it is desired that the bias applied to the potential regulating member 8 is a bias such that primary transfer efficiency does not become a target value or less by a current flowing through the potential regulating member 8 from the primary transfer portion N1 or a potential difference between a primary transfer voltage applied to the primary transfer portion N1 and a potential regulating voltage applied to the potential regulating member 8. Not only the electric discharge on the side downstream of the primary transfer portion N1 can be sufficiently suppressed, but also a set value of the bias at which a primary transfer property can be maintained and which is applied to the potential regulating member 8 can be determined in advance by an experiment or the like. Further, with a higher bias, a possibility of generation of the gap electric discharge is higher.

Accordingly, even in the case where the bias applied to the potential regulating member 8 is relatively high or in the like case, it is desired that the electrostatic adsorption force generated between the intermediary transfer belt 6 and the potential regulating member 8 is reduced and thus the traveling property of the intermediary transfer belt 6 is stabilized. In order to reduce the electrostatic adsorption force generated between the intermediary transfer belt 6 and the potential regulating member 8, it is effective that the contact area of the contact surface 83 of the potential regulating member 8 with the inner peripheral surface of the intermediary transfer belt 6 is reduced.

Parts (a) and (b) of FIG. 7 are schematic views showing a surface shape of the contact surface 83 of the potential regulating member 8 in this embodiment. Incidentally, the potential regulating member 8 has the constitution described with reference to FIG. 3 and of which first portion 81 is constituted by a metal plate of about 2 mm in thickness. In parts (a) and (b) of FIG. 7, the second portion 82 of the potential regulating member 8 is omitted from illustration, and a part of the contact surface 83 is schematically shown. Part (a) of FIG. 7 is a schematic plan view in which the contact surface 83 of the potential regulating member 8 is viewed from an inner peripheral surface side of the intermediary transfer belt 6. Further, part (b) of FIG. 7 is a schematic sectional view (sectional view taken along A-A line of part (a) of FIG. 7) in which the potential regulating member 8 is cut in the feeding direction of the intermediary transfer belt 6.

Incidentally, as regards the image forming apparatus 1 or elements (such as the intermediary transfer belt 6) thereof, a front side of a drawing sheet of FIG. 1 is a "front side", and a rear side of the drawing sheet is a "rear side". A rectilinear line connecting the front side and the rear side is substantially parallel to the rotational axis direction (widthwise direction of the intermediary transfer belt 6) of the photosensitive drum 11. In addition, in parts (a) and (b) of FIG. 7, the feeding direction of the intermediary transfer belt 6 is an "X direction" (the direction from the downstream side toward the upstream side is a positive (+) direction, and the widthwise direction (direction perpendicular to the X direction) is a "Y direction" (the direction from the front side toward the rear side is a positive (+) direction). In addition, in parts (a) and (b) of FIG. 7, a direction perpendicular to the X direction and the Y direction is a "Z direction" (the direction from the potential regulating member 8 side (lower side) toward the intermediary transfer belt 6 side (upper side) is a positive (+) direction). The X direction, the Y direction, and the Z direction are the same as those defined above also in parts (a) and (b) of FIG. 9 to parts (a) and (b) of FIG. 12 described later.

In this embodiment, the contact surface 83 of the potential regulating member 8 includes a projected portion 81a and a recessed portion 81b. The projected portion 81a is projected toward the inner peripheral surface of the intermediary transfer belt 7 relative to the recessed portion 81b. The recessed portion 81b is recessed (retracted) in a direction in which the recessed portion 81b is separated from the inner peripheral surface of the intermediary transfer belt 6 relative to the projected portion 81a. The recessed portion 81b forms a non-contact region (separation region) separated from the inner peripheral surface of the intermediary transfer belt 6 when a contact region formed by the projected portion 81a in the contact surface 83 contacts the inner peripheral surface of the intermediary transfer belt 6. Incidentally, for convenience, in part (a) of FIG. 7, the recessed portion 81b is represented by dots. A surface (top portion) of the projected portion 81a opposing the inner peripheral surface of the intermediary transfer belt 6 constitutes the contact region contactable to the inner peripheral surface of the intermediary transfer belt 6. In this embodiment, the contact surface 83 of the potential regulating member 8 has a surface shape such that a plurality of independent projected portions 81a are projected toward the inner peripheral surface of the intermediary transfer belt 6. Herein, such a surface shape is also referred to as an "embossed shape". In this embodiment, the surface formed by the plurality of projected portions 81a is a substantially flat surface.

A ratio of a decrease amount of a contact area, due to provision of the uneven shape to the contact surface 83 of the potential regulating member 8, to a contact area with the inner peripheral surface of the intermediary transfer belt 6 in the case where the uneven shape is not provided to the contact surface 83 of the potential regulating member 8 is defined as a contact area decrease amount (%). The contact area in the case where the above-described uneven shape is not provided corresponds to a contact area in the case where a region corresponding to the recessed portion 81b is assumed to be flash with the projected portions 81a. At this time, the contact area decrease amount may preferably be 10 % or more, more preferably 20 % or more. When the contact area decrease amount is excessively small, it becomes difficult to suppress a lowering in traveling property of the intermediary transfer belt 6 by sufficiently suppressing the electrostatic adsorption force between the potential regulating member 8 and the intermediary transfer belt 6. On the other hand, the contact area decreases amount may preferably be 70 % or less, more preferably 50 % or less. When the contact area decrease amount is excessively large, there is a possibility that processing accuracy of the potential regulating member 8 (particularly, the contact area contactable to the inner peripheral surface of the intermediary transfer belt 6) lowers. That is, the contact area decrease amount may preferably be 10 to 70 %, more preferably 20 to 50 %. According to study the present inventors, it was found that by making the contact area decrease amount in such a range, the lowering in traveling property of the intermediary transfer belt 6 can be suppressed by sufficiently suppressing the electrostatic adsorption force between the potential regulating member 8 and the intermediary transfer belt 6. In addition, according to study by the present inventors, it was found that in the contact area decrease amount in such a range, the electric discharge suppressing effect between the photosensitive drum 11 and the intermediary transfer belt 6 can be maintained. Here, the contact area decrease amount can also be said as a ratio of an area of the region (non-contact region) in the contact surface 83, in which the potential regulating member 8 does not contact the intermediary transfer belt 6, to an area of the contact surface 83 when the contact surface 83 is viewed from the inner peripheral surface side of the intermediary transfer belt 6 along a direction substantially perpendicular to the contact surface 83. Further, the contact surface 83 of the potential regulating member 8 is, more specifically, a surface provided with the contact region, contactable to the inner peripheral surface of the intermediary transfer belt 6, constituted by a surface opposing the inner peripheral surface of the intermediary transfer belt 6.

Incidentally, in other words, a contact area amount (%) which is a ratio of the contact area in the case where the contact surface 83 of the potential regulating member 8 is provided with the uneven shape when the contact area of the contact surface 83 with the inner peripheral surface of the intermediary transfer belt 6 in the case where the contact surface 83 of the potential regulating member 8 is not provided with the uneven shape is taken as 100 % may preferably be 30 to 90 %, more preferably 50 to 80 %. Here, the contact area amount can also be said as a ratio of an area of the region (contact region) in the contact surface 83, in which the potential regulating member 8 contacts the intermediary transfer belt 6, to an area of the contact surface 83 when the contact surface 83 is viewed from the inner peripheral surface side of the intermediary transfer belt 6 along a direction substantially perpendicular to the contact surface 83.

The contact area decrease amount may preferably fall within the above-described range not only in a whole region of the contact surface 83 of the potential regulating member 8 but also in a part of the region of the contact surface 83 of the potential regulating member 8, and it is more preferable that the contact area decrease amount in the whole region and the contact area decrease amount in the part of the region are substantially the same. The case where there is a fluctuation of a degree of error in contact area decrease amount (for example, a fluctuation of ±15 % or less) is also included in the case of "substantially the same". That is, the contact area decrease amount (%) can be regarded as a ratio of an area of the non-contact region in a unit region in an arbitrary position when the contact surface 83 is viewed from the inner peripheral surface side of the intermediary transfer belt 6, to an area of the unit region. Further, this contact area decrease amount (%) may preferably fall within the above-described range. The above-described unit region is, for example, each of a front-side half region and a rear-side half region with respect to the widthwise direction of the intermediary transfer belt 6 (with respect to the longitudinal direction of the potential regulating member 8). Further, the above-described unit region is, for example, each of regions in the case where each region has a predetermined shape (for example, a square of which one side is 10 mm) in an arbitrary position of the contact surface 83. That is, it is preferable that even when the contact surface 83 of the potential regulating member 8 is provided with the uneven shape, the contact region contactable to the inner peripheral surface of the intermediary transfer belt 6 is distributed substantially uniformly.

In this embodiment, the contact surface 83 of the potential regulating member 8 is provided with a plurality of independent projected portions 81a arranged so that a plurality of lines each including the independent projected portions 81a arranged regularly (substantially equidistantly in this embodiment) along (in this embodiment, substantially parallel to) the feeding direction of the intermediary transfer belt 6 are provided regularly (substantially equidistantly in this embodiment) along (in this embodiment, substantially parallel to) the widthwise direction of the intermediary transfer belt 6. In this embodiment, each of the projected portions 81a of each line in the widthwise direction of the intermediary transfer belt 6 is provided so as not to overlap with the projected portions 81a of adjacent lines with respect to the feeding direction of the intermediary transfer belt 6. Further, in this embodiment, each projected portion 81a has a substantially square shape having a side extending along (in this embodiment, substantially parallel to the feeding direction of the intermediary transfer belt 6 and having a side extending along (in this embodiment substantially parallel to) the widthwise direction of the intermediary transfer belt 6 when the projected portion 81a is viewed from the inner peripheral surface side of the intermediary transfer belt 6. When a contact area between the potential regulating member 8 and the inner peripheral surface of the intermediary transfer belt 6 can be sufficiently decreased (preferably when the above-described contact area decrease amount can be achieved), a size of each projected portion 81a and an interval (pitch) between adjacent projected portions 81a can be appropriately set. An interval (pitch) d1 between the projected portions 81a with respect to the feeding direction (and the widthwise direction) of the intermediary transfer belt 6 can be set to about 0.1 to 3 mm, and in this embodiment, from a viewpoint of processing accuracy, the interval (pitch) d1 may preferably be about 0.1 to 1 mm. Further, in this embodiment, a surface (top) of the projected portion 81a opposing (contacting) the inner peripheral surface of the intermediary transfer belt 6 is flat. Further, a length (width) w1 of one side of the projected portion 81a when the projected portion 81a is viewed from the inner peripheral surface side of the intermediary transfer belt 6 can be set to, for example, about 0.1 to 3 mm, and in this embodiment, from a viewpoint of processing accuracy or the like, the length (width) w1 may preferably be about 0.1 to 1 mm. In addition, a height h1 of the projected portion 81a can be set to about 0.05 to 1 mm, and in a constitution of this embodiment, from the viewpoint of the processing accuracy or the like, the height h1 may preferably be about 0.05 to 0.5 mm. Further, the height h1 of the projected portion 81a may preferably be substantially constant in the contact surface 83, i.e., a substantially flat surface may preferably be formed by tops of the plurality of projected portions 81a. Incidentally, the case where there is a fluctuation of a degree of error in height of the projected portion (depth of the recessed portion) (for example, the case where there is a fluctuation of ±15 % or less) is also included in the case of "substantially constant". Further, in this embodiment, a region of the recessed portion 81b is equal to a region other than the projected portions 81a, and a bottom thereof may also be nonflat.

The contact surface 83 of the potential regulating member 8 has such an uneven shape, so that the contact area between the potential regulating member 8 and the inner peripheral surface of the intermediary transfer belt 5 can be decreased.

Incidentally, in this embodiment, the projected portion 81a has the substantially square shape when the projected portion 81a is viewed from the inner peripheral surface side of the intermediary transfer belt 6, but the shape of the projected portion 81a is not limited thereto. This shape is arbitrary when the contact area between the potential regulating member 8 and the inner peripheral surface of the intermediary transfer belt 6 can be sufficiently decreased (preferably, the above-described contact area decrease amount can be achieved). For example, this shape may be polygons such as a triangle, a quadrangle (square, rectangle), a pentagon, and a hexagon, or a circle, an ellipse, an oval, and the like. The projected portions 81a may have the substantially same shape for all thereof or may have different shapes for at least a part thereof. Here, in this embodiment, in the case where the shape of the projected portion 81a is the circle, for example, a diameter of the circle can be made equal to the length of one side of a square projected portion 81a. Further, in this embodiment, in the case where the shape of the projected portion 81a is a shape, other than the square and the circle, such as the polygons other than the square, for example, a diameter of a circumscribed circle thereof can be made equal to the length of one side of the square projected portion 81a in this embodiment.

Further, the contact surface 83 of the potential regulating member 8 can be provided with the uneven shape by an available arbitrary method. For example, it is possible to cite pressing, cutting, polishing, chemical surface treatment (etching), and the like. A plurality of processing methods may be used in combination. In this embodiment, the first portion 81 of the potential regulating member 8 constituted by a metal plate of about 2 mm in thickness is subjected to the pressing, so that the uneven shape was formed on the contact surface 83.

As described above, according to this embodiment, even in the case where the relatively high voltage is applied to the potential regulating member 8, the electrostatic adsorption force between the intermediary transfer belt 6 and the potential regulating member 8 is reduced, so that it becomes possible to suppress that the traveling of the intermediary transfer belt 7 becomes unstable. Therefore, according to this embodiment, in a constitution in which the bias is applied to the potential regulating member 8 disposed on the side downstream of the primary transfer portion N1, it is possible to suppress that the traveling property of the intermediary transfer belt 6 becomes unstable.

### Embodiment 2

Next, another embodiment of the present disclosure will be described. The basic structure and operation of an image forming apparatus of this embodiment are the same as those of the image forming apparatus of the embodiment 1. Therefore, in the image forming apparatus of this embodiment, elements having the same or corresponding functions or structures as those of the image forming apparatus of the embodiment 1 are denoted by the same reference numerals or symbols as those of the embodiment 1, and detailed description thereof will be omitted.

In this embodiment, the potential regulating members 8y, 8m, 8c, and 8k provided in the primary transfer portions N1y, N1m, N1c, and N1k have the substantially same constitution. Further, in this embodiment, the surface shape of the contact surface 83 of the potential regulating member 8 is different from the surface shape of the contact surface 83 of the potential regulating member 8 in the embodiment 1. In the following, description will be made specifically.

Parts (a) and (b) of FIG. 8 are schematic views showing a surface shape of the contact surface 83 of the potential regulating member 8 in this embodiment. Incidentally, the potential regulating member 8 has the constitution described with reference to FIG. 3 and of which first portion 81 is constituted by a metal plate of about 2 mm in thickness. In parts (a) and (b) of FIG. 8, the second portion 82 of the potential regulating member 8 is omitted from illustration, and a part of the contact surface 83 is schematically shown. Part (a) of FIG. 8 is a schematic plan view in which the contact surface 83 of the potential regulating member 8 is viewed from an inner peripheral surface side of the intermediary transfer belt 6. Further, part (b) of FIG. 8 is a schematic sectional view (sectional view taken along B-B line of part (a) of FIG. 8) in which the potential regulating member 8 is cut in the widthwise direction of the intermediary transfer belt 6.

In this embodiment, the contact surface 83 of the potential regulating member 8 includes a projected portion 81a and a recessed portion 81b. The projected portion 81a is projected toward the inner peripheral surface of the intermediary transfer belt 7 relative to the recessed portion 81b. The recessed portion 81b is recessed in a direction in which the recessed portion 81b is separated from the inner peripheral surface of the intermediary transfer belt 6 relative to the projected portion 81a. Incidentally, for convenience, in part (a) of FIG. 8, the recessed portion 81b is represented by dots. A surface (top portion) of the projected portion 81a opposing the inner peripheral surface of the intermediary transfer belt 6 constitutes the contact region contactable to the inner peripheral surface of the intermediary transfer belt 6. In this embodiment, the contact surface 83 of the potential regulating member 8 has a surface shape such that a plurality of band-like projected portions 81a extending along (in this embodiment, substantially parallel to) the feeding direction of the intermediary transfer belt 6 are projected toward the inner peripheral surface of the intermediary transfer belt 6. Herein, such a surface shape is also referred to as a "lateral band". Incidentally, this surface shape can also be said as a surface shape such that a plurality of band-like recessed portions 81b extending along (in this embodiment, substantially parallel to) the feeding direction of the intermediary transfer belt 6 are recessed from the inner peripheral surface of the intermediary transfer belt 6. In this embodiment, the surface formed by the plurality of projected portions 81a is a substantially flat surface.

In this embodiment, the contact surface 83 of the potential regulating member 8 is provided with a plurality of projected portions 81a each extending linearly along (in this embodiment, substantially parallel to) the feeding direction of the intermediary transfer belt 6 are provided regularly (substantially equidistantly in this embodiment) along (in this embodiment, substantially parallel to) the widthwise direction of the intermediary transfer belt 6. When a contact area between the potential regulating member 8 and the inner peripheral surface of the intermediary transfer belt 6 can be sufficiently decreased (preferably when the contact area decrease amount described in the embodiment 1 can be achieved), a size of each projected portion 81a and an interval (pitch) between adjacent projected portions 81a can be appropriately set. An interval (pitch) d2 between the projected portions 81a with respect to the widthwise direction of the intermediary transfer belt 6 can be set to about 0.1 to 3 mm, and in this embodiment, from a viewpoint of processing accuracy, the interval (pitch) d2 may preferably be about 0.1 to 1 mm. Further, in this embodiment, a surface (top) of the projected portion 81a opposing (contacting) the inner peripheral surface of the intermediary transfer belt 6 is flat. Further, a width w2 of the projected portion 81a with respect to the widthwise direction of the intermediary transfer belt 6 can be set to, for example, about 0.1 to 3 mm, and in this embodiment, from a viewpoint of processing accuracy or the like, the width w2 may preferably be about 0.1 to 1 mm. In addition, a height h2 of the projected portion 81a can be set to about 0.05 to 1 mm, and in a constitution of this embodiment, from the viewpoint of the processing accuracy or the like, the height h2 may preferably be about 0.05 to 0.5 mm. Further, the height h2 of the projected portion 81a may preferably be substantially constant in the contact surface 83, i.e., a substantially flat surface may preferably be formed by tops of the plurality of projected portions 81a. Further, in this embodiment, a region of the recessed portion 81b is equal to a region other than the projected portions 81a, and a bottom thereof may also be nonflat.

The contact surface 83 of the potential regulating member 8 has such an uneven shape, so that similarly as the embodiment 1, the contact area between the potential regulating member 8 and the inner peripheral surface of the intermediary transfer belt 5 can be decreased.

Further, as described in the embodiment 1, the contact surface 83 of the potential regulating member 8 can be provided with the uneven shape by an available arbitrary method. In this embodiment, the first portion 81 of the potential regulating member 8 constituted by a metal plate of about 2 mm in thickness is subjected to the pressing, so that the uneven shape was formed on the contact surface 83.

As described above, also by a constitution of this embodiment, similarly as the embodiment 1, in a constitution in which the bias is applied to the potential regulating member 8 disposed on the side downstream of the primary transfer portion N1, it is possible to suppress that the traveling property of the intermediary transfer belt 6 becomes unstable.

### Embodiment 3

Next, another embodiment of the present disclosure will be described. The basic structure and operation of an image forming apparatus of this embodiment are the same as those of the image forming apparatus of the embodiments 1 and 2. Therefore, in the image forming apparatus of this embodiment, elements having the same or corresponding functions or structures as those of the image forming apparatus of the embodiments 1 and 2 are denoted by the same reference numerals or symbols as those of the embodiments 1 and 2, and detailed description thereof will be omitted.

In this embodiment, the potential regulating members 8y, 8m, 8c, and 8k provided in the primary transfer portions N1y, N1m, N1c, and N1k have the substantially same constitution. Further, in this embodiment, the surface shape of the contact surface 83 of the potential regulating member 8 is different from the surface shapes of the contact surfaces 83 of the potential regulating members 8 in the embodiments 1 and 2. In the following, description will be made specifically.

Parts (a) and (b) of FIG. 9 are schematic views showing a surface shape of the contact surface 83 of the potential regulating member 8 in this embodiment. Incidentally, the potential regulating member 8 has the constitution described with reference to FIG. 3 and of which first portion 81 is constituted by a metal plate of about 2 mm in thickness. In parts (a) and (b) of FIG. 9, the second portion 82 of the potential regulating member 8 is omitted from illustration, and a part of the contact surface 83 is schematically shown. Part (a) of FIG. 9 is a schematic plan view in which the contact surface 83 of the potential regulating member 8 is viewed from an inner peripheral surface side of the intermediary transfer belt 6. Further, part (b) of FIG. 9 is a schematic sectional view (sectional view taken along B-B line of part (a) of FIG. 9) in which the potential regulating member 8 is cut in the feeding direction of the intermediary transfer belt 6.

In this embodiment, the contact surface 83 of the potential regulating member 8 includes a projected portion 81a and a recessed portion 81b. The projected portion 81a is projected toward the inner peripheral surface of the intermediary transfer belt 7 relative to the recessed portion 81b. The recessed portion 81b is recessed in a direction in which the recessed portion 81b is separated from the inner peripheral surface of the intermediary transfer belt 6 relative to the projected portion 81a. Incidentally, for convenience, in part (a) of FIG. 9, the recessed portion 81b is represented by dots. A surface (top portion) of the projected portion 81a opposing the inner peripheral surface of the intermediary transfer belt 6 constitutes the contact region contactable to the inner peripheral surface of the intermediary transfer belt 6. In this embodiment, the contact surface 83 of the potential regulating member 8 has a surface shape such that a plurality of band-like projected portions 81a extending along (in this embodiment, substantially parallel to) the feeding direction of the intermediary transfer belt 6 are projected toward the inner peripheral surface of the intermediary transfer belt 6. Herein, such a surface shape is also referred to as a "vertical band". Incidentally, this surface shape can also be said as a surface shape such that a plurality of band-like recessed portions 81b extending along (in this embodiment, substantially parallel to) the widthwise direction of the intermediary transfer belt 6 are recessed from the inner peripheral surface of the intermediary transfer belt 6. In this embodiment, the surface formed by the plurality of projected portions 81a is a substantially flat surface.

In this embodiment, the contact surface 83 of the potential regulating member 8 is provided with a plurality of projected portions 81a each extending linearly along (in this embodiment, substantially parallel to) the widthwise direction of the intermediary transfer belt 6 are provided regularly (substantially equidistantly in this embodiment) along (in this embodiment, substantially parallel to) the feeding direction of the intermediary transfer belt 6. When a contact area between the potential regulating member 8 and the inner peripheral surface of the intermediary transfer belt 6 can be sufficiently decreased (preferably when the contact area decrease amount described in the embodiment 1 can be achieved), a size of each projected portion 81a and an interval (pitch) between adjacent projected portions 81a can be appropriately set. An interval (pitch) d3 between the projected portions 81a with respect to the feeding direction of the intermediary transfer belt 6 can be set to about 0.1 to 3 mm, and in this embodiment, from a viewpoint of processing accuracy, the interval (pitch) d3 may preferably be about 0.1 to 1 mm. Further, in this embodiment, a surface (top) of the projected portion 81a opposing (contacting) the inner peripheral surface of the intermediary transfer belt 6 is flat. Further, a width w3 of the projected portion 81a with respect to the feeding direction of the intermediary transfer belt 6 can be set to, for example, about 0.1 to 3 mm, and in this embodiment, from a viewpoint of processing accuracy or the like, the width w3 may preferably be about 0.1 to 1 mm. In addition, a height h3 of the projected portion 81a can be set to about 0.05 to 1 mm, and in a constitution of this embodiment, from the viewpoint of the processing accuracy or the like, the height h3 may preferably be about 0.05 to 0.5 mm. Further, the height h3 of the projected portion 81a may preferably be substantially constant in the contact surface 83, i.e., a substantially flat surface may preferably be formed by tops of the plurality of projected portions 81a. Further, in this embodiment, a region of the recessed portion 81b is equal to a region other than the projected portions 81a, and a bottom thereof may also be nonflat.

The contact surface 83 of the potential regulating member 8 has such an uneven shape, so that similarly as the embodiments 1 and 2, the contact area between the potential regulating member 8 and the inner peripheral surface of the intermediary transfer belt 5 can be decreased.

Further, as described in the embodiment 1, the contact surface 83 of the potential regulating member 8 can be provided with the uneven shape by an available arbitrary method. In this embodiment, the first portion 81 of the potential regulating member 8 constituted by a metal plate of about 2 mm in thickness is subjected to the pressing, so that the uneven shape was formed on the contact surface 83.

As described above, also by a constitution of this embodiment, similarly as the embodiments 1 and 2, in a constitution in which the bias is applied to the potential regulating member 8 disposed on the side downstream of the primary transfer portion N1, it is possible to suppress that the traveling property of the intermediary transfer belt 6 becomes unstable.

Further, in this embodiment, in any position of the contact surface 83 with respect to the widthwise direction of the intermediary transfer belt 6, the uneven shape of the contact surface 83 is formed so that a contact region with the inner peripheral surface of the intermediary transfer belt 6 exists in at least a part thereof with respect to the feeding direction of the intermediary transfer belt 6. A further effect by such a surface shape of the contact surface 83 of the potential regulating member 8 will be described in an embodiment 4 below.

### Embodiment 4

Next, another embodiment of the present disclosure will be described. The basic structure and operation of an image forming apparatus of this embodiment are the same as those of the image forming apparatus of the embodiments 1 to 3. Therefore, in the image forming apparatus of this embodiment, elements having the same or corresponding functions or structures as those of the image forming apparatus of the embodiments 1 to 3 are denoted by the same reference numerals or symbols as those of the embodiments 1 to 3, and detailed description thereof will be omitted.

In this embodiment, a surface shape of the contact surface 83 of the potential regulating member 8 is different from the surface shapes in the embodiments 1 and 2. Further, in this embodiment, a problem other than the problem described in the embodiment 1 and a solution to the problem will be also described.

In the image forming apparatus 1 of the intermediary transfer type, foreign matters such as toner, an external additive, paper powder, and the like, which move from spaces in the neighborhood of opposite end portions of the intermediary transfer belt 6 with respect to the widthwise direction toward the inner peripheral surface side of the intermediary transfer belt 6 are deposited on the inner peripheral surface of the intermediary transfer belt 6 in some instances. Further, for example, in the case where as a material of the primary transfer rollers 15 and the inner secondary transfer roller 23, a sponge is used, a substance bleeding out from the sponge is deposited as the foreign matter on the inner peripheral surface of the intermediary transfer belt 6 in some cases. In a portion where such foreign matters are deposited on the inner peripheral surface of the intermediary transfer belt 6, there is a liability that transfer efficiency lowers or the like and the toner image is not normally transferred onto the recording material S, and thus an image quality lowers. For that reason, it is desired that the foreign matters are removed from the inner peripheral surface of the intermediary transfer belt 6.

In this embodiment, the potential regulating members 8y, 8m, 8c, and 8k provided in the primary transfer portions N1y, N1m, N1c, and N1k have the substantially same constitution. Further, in this embodiment, the shape of the potential regulating member 8 is different from the surface shapes of the contact surfaces 83 of the potential regulating members 8 in the embodiments 1 to 3. In this embodiment, the surface shape of the contact surface 83 of the potential regulating member 8 is such that the surface shape is effective in not only reducing the contact area between the potential regulating member 8 and the inner peripheral surface of the intermediary transfer belt 6 but also removing the foreign matters from the inner peripheral surface of the intermediary transfer belt 6. In the following, description will be made specifically.

Parts (a) and (b) of FIG. 10 are schematic views showing a surface shape of the contact surface 83 of the potential regulating member 8 in this embodiment. Incidentally, the potential regulating member 8 has the constitution described with reference to FIG. 3 and of which first portion 81 is constituted by a metal plate of about 2 mm in thickness. In parts (a) and (b) of FIG. 10, the second portion 82 of the potential regulating member 8 is omitted from illustration, and a part of the contact surface 83 is schematically shown. Part (a) of FIG. 10 is a schematic plan view in which the contact surface 83 of the potential regulating member 8 is viewed from an inner peripheral surface side of the intermediary transfer belt 6. Further, part (b) of FIG. 10 is a schematic sectional view (sectional view taken along D-D line of part (a) of FIG. 10) in which the potential regulating member 8 is cut in the widthwise direction of the intermediary transfer belt 6.

In this embodiment, the contact surface 83 of the potential regulating member 8 includes a projected portion 81a and a recessed portion 81b. The projected portion 81a is projected toward the inner peripheral surface of the intermediary transfer belt 7 relative to the recessed portion 81b. The recessed portion 81b is recessed in a direction in which the recessed portion 81b is separated from the inner peripheral surface of the intermediary transfer belt 6 relative to the projected portion 81a. Incidentally, for convenience, in part (a) of FIG. 10, the recessed portion 81b is represented by dots. A surface (top portion) of the projected portion 81a opposing the inner peripheral surface of the intermediary transfer belt 6 constitutes the contact region contactable to the inner peripheral surface of the intermediary transfer belt 6. In this embodiment, the contact surface 83 of the potential regulating member 8 has a surface shape such that a plurality of band-like projected portions 81a extending along (in this embodiment, substantially parallel to) the feeding direction of the intermediary transfer belt 6 are projected toward the inner peripheral surface of the intermediary transfer belt 6. Herein, such a surface shape is also referred to as an "inclined band". Incidentally, this surface shape can also be said as a surface shape such that a plurality of band-like recessed portions 81b extending so as to be inclined with an angle with respect to the feeding direction of the intermediary transfer belt 6 are recessed from the inner peripheral surface of the intermediary transfer belt 6. In this embodiment, the surface formed by the plurality of projected portions 81a is a substantially flat surface.

In this embodiment, the contact surface 83 of the potential regulating member 8 is provided with a plurality of projected portions 81a each extending linearly along (in this embodiment, substantially parallel to) the feeding direction of the intermediary transfer belt 6 are provided regularly (substantially equidistantly in this embodiment) along the widthwise direction of the intermediary transfer belt 6. However, in this embodiment, each projected portion 81a extends so as to be inclined with the angle with respect to the feeding direction of the intermediary transfer belt 6. Further, in this embodiment, the plurality of projected portions 81a are formed so that in any position of the contact surface 83 with respect to the widthwise direction of the intermediary transfer belt 6, a contact region with the inner peripheral surface of the intermediary transfer belt 6 exists in at least a part thereof with respect to the feeding direction of the intermediary transfer belt 6. That is, in this embodiment, the projected portions 81a are formed so that at least a part of each of adjacent projected portions 81a overlaps with each other with respect to the widthwise direction of the intermediary transfer belt 6. When a contact area between the potential regulating member 8 and the inner peripheral surface of the intermediary transfer belt 6 can be sufficiently decreased (preferably when the contact area decrease amount described in the embodiment 1 can be achieved), a size of each projected portion 81a and an interval (pitch) between adjacent projected portions 81a can be appropriately set. Further, as described above, when at least a part of each of the adjacent projected portions 81a overlaps with each other with respect to the widthwise direction of the intermediary transfer belt 6, an angle formed between an extending direction of the projected portion 81a and the feeding direction of the intermediary transfer belt 6 can be appropriately set. An interval (pitch) d4 between the projected portions 81a with respect to the widthwise direction of the intermediary transfer belt 6 can be set to about 0.1 to 3 mm, and in this embodiment, from a viewpoint of processing accuracy, the interval (pitch) d4 may preferably be about 0.5 to 2 mm. Further, in this embodiment, a surface (top) of the projected portion 81a opposing (contacting) the inner peripheral surface of the intermediary transfer belt 6 is flat. Further, a width w4 of the projected portion 81a with respect to a direction substantially perpendicular to an extending direction of the projected portion 81a can be set to, for example, about 0.1 to 3 mm, and in this embodiment, from a viewpoint of processing accuracy or the like, the width w4 may preferably be about 0.1 to 1 mm. In addition, a height h4 of the projected portion 81a can be set to about 0.05 to 1 mm, and in a constitution of this embodiment, from the viewpoint of the processing accuracy or the like, the height h4 may preferably be about 0.05 to 0.5 mm. Further, the height h4 of the projected portion 81a may preferably be substantially constant in the contact surface 83, i.e., a substantially flat surface may preferably be formed by tops of the plurality of projected portions 81a. Further, the angle formed between the extending direction of the projected portion 81a and the feeding direction of the intermediary transfer belt 6 can be set to, for example, about 5 to 45 degrees, preferably about 10 to 30 degrees. Further, in this embodiment, a region of the recessed portion 81b is equal to a region other than the projected portions 81a, and a bottom thereof may also be nonflat.

The contact surface 83 of the potential regulating member 8 has such an uneven shape, so that similarly as the embodiments 1 to 3, the contact area between the potential regulating member 8 and the inner peripheral surface of the intermediary transfer belt 5 can be decreased.

Further, by causing at least a part of each of the adjacent projected portions 81a to overlap with each other with respect to the widthwise direction of the intermediary transfer belt 6, the foreign matters in a substantially whole region (region of contact of the contact surface 83 with the intermediary transfer belt 6) with respect to the widthwise direction of the intermediary transfer belt 6 can be scraped off by the projected portions 81a. Further, each of the projected portions 81a is formed in the shape such that the projected portion 81a is inclined with respect to the feeding direction of the intermediary transfer belt 6, so that the foreign matters, are suppressed from remaining on the potential regulating member 8. Further, at least a part of the foreign matters removed from the inner peripheral surface of the intermediary transfer belt 6 by the potential regulating member 8 is moved in the feeding direction along the uneven shape of the contact surface 83, for example, with movement of the intermediary transfer belt 6 and then is removed from the potential regulating member 8.

Incidentally, the image forming apparatus 1 may include an accommodating portion (not shown) for accommodating the foreign matters removed from the potential regulating member 8 and dropped, for example, by the action of gravitation. As in this embodiment, a constitution in which the foreign matters are removed from the inner peripheral surface of the intermediary transfer belt 6 by the potential regulating member 8 can be said particularly effective in the case where a dedicated member (scrape or brush) for cleaning the inner peripheral surface of the intermediary transfer belt 6 is not provided.

Further, as described in the embodiment 1, the contact surface 83 of the potential regulating member 8 can be provided with the uneven shape by an available arbitrary method. In this embodiment, the first portion 81 of the potential regulating member 8 constituted by a metal plate of about 2 mm in thickness is subjected to the pressing, so that the uneven shape was formed on the contact surface 83.

Incidentally, also in the embodiment 3, the uneven shape of the contact surface 83 is formed so that in any position of the contact surface 83 with respect to the widthwise direction of the intermediary transfer belt 6, the contact region with the inner peripheral surface of the intermediary transfer belt 6 exists in at least a part of a portion thereof with respect to the feeding direction of the intermediary transfer belt 6. However, in the embodiment 3, the projected portions 81a extend in the direction substantially perpendicular to the feeding direction of the intermediary transfer belt 6, and therefore, it can be said that compared with this embodiment, the foreign matters are liable to remain on the potential regulating member 8. Accordingly, from a viewpoint of removal of the foreign matters from the inner peripheral surface of the intermediary transfer belt 6, the uneven shape in this embodiment is preferred.

As described above, also by a constitution of this embodiment, similarly as the embodiment 1, in a constitution in which the bias is applied to the potential regulating member 8 disposed on the side downstream of the primary transfer portion N1, it is possible to suppress that the traveling property of the intermediary transfer belt 6 becomes unstable. Further, the constitution of this embodiment is advantageous for removing the foreign matters from the inner peripheral surface of the intermediary transfer belt 6 by the potential regulating member 8.

### Embodiment 5

Next, another embodiment of the present disclosure will be described. The basic structure and operation of an image forming apparatus of this embodiment are the same as those of the image forming apparatus of the embodiments 1 to 4. Therefore, in the image forming apparatus of this embodiment, elements having the same or corresponding functions or structures as those of the image forming apparatus of the embodiments 1 to 4 are denoted by the same reference numerals or symbols as those of the embodiments 1 to 4, and detailed description thereof will be omitted.

In this embodiment, the potential regulating members 8y, 8m, 8c, and 8k provided in the primary transfer portions N1y, N1m, N1c, and N1k have the substantially same constitution. Further, in this embodiment, the shape of the potential regulating member 8 is different from the shape of the potential regulating member 8 in the embodiments 1 to 4. In the following, description will be made specifically.

Parts (a) and (b) of FIG. 11 are schematic views showing a surface shape of the contact surface 83 of the potential regulating member 8 in this embodiment. Incidentally, the potential regulating member 8 has the constitution described with reference to FIG. 3 and of which first portion 81 is constituted by a metal plate of about 2 mm in thickness. In parts (a) and (b) of FIG. 11, the second portion 82 of the potential regulating member 8 is omitted from illustration. Part (a) of FIG. 11 is a schematic plan view in which the contact surface 83 of the potential regulating member 8 is viewed from an inner peripheral surface side of the intermediary transfer belt 6. Further, part (b) of FIG. 11 is a schematic sectional view (sectional view taken along E-E line of part (a) of FIG. 11) in which the potential regulating member 8 is cut in the widthwise direction of the intermediary transfer belt 6.

In this embodiment, the contact surface 83 of the potential regulating member 8 includes a projected portion 81a and a recessed portion 81b. The projected portion 81a is projected toward the inner peripheral surface of the intermediary transfer belt 7 relative to the recessed portion 81b. The recessed portion 81b is recessed in a direction in which the recessed portion 81b is separated from the inner peripheral surface of the intermediary transfer belt 6 relative to the projected portion 81a. Incidentally, for convenience, in part (a) of FIG. 11, the recessed portion 81b is represented by dots. A surface of the projected portion 81a opposing the inner peripheral surface of the intermediary transfer belt 6 constitutes the contact region contactable to the inner peripheral surface of the intermediary transfer belt 6. In this embodiment, the contact surface 83 of the potential regulating member 8 has a surface shape such that a plurality of independent recessed portions 81b are recessed in a direction in which the recessed portions 81b are separated from the inner peripheral surface of the intermediary transfer belt 6. Herein, such a surface shape is also referred to as a kind of an "embossed shape (or debossed shape)". In this embodiment, a remaining region of the contact surface 83 on which the plurality of recessed portions 81b are formed is a substantially flat surface.

Also in this embodiment, similarly as in the embodiments 1 to 4, the contact surface decrease amount due to provision of the uneven shape to the contact surface 83 of the potential regulating member 8 may preferably be 10 to 70 %, more preferably 20 to 50 %. Further, also in this embodiment, even when the contact surface 83 of the potential regulating member 8 is provided with the uneven shape, on the contact surface 83, a contact region contactable to the inner peripheral surface of the intermediary transfer belt 6 is substantially uniformly distributed. As in this embodiment, the surface shape such that an original flat surface of the contact surface 83 constitutes the contact region with the inner peripheral surface of the intermediary transfer belt 6 has an advantage that flatness of the contact region is readily realized mechanically.

In this embodiment, the contact surface 83 of the potential regulating member 8 is provided with a plurality of independent recessed portions 81b arranged so that a plurality of lines each including the independent recessed portions 81b arranged regularly (substantially equidistantly in this embodiment) along (in this embodiment, substantially parallel to) the widthwise direction of the intermediary transfer belt 6 are provided along (in this embodiment, substantially parallel to) the feeding direction of the intermediary transfer belt 6. In this embodiment, each of the recessed portions 81b of each line in the feeding direction is provided so that at least a part thereof overlaps with the recessed portions 81b of adjacent lines with respect to the widthwise direction of the intermediary transfer belt. Thus, in this embodiment, the contact surface 83 is provided with the recessed portions 81b in a staggered pattern (staggered embossing). Further, in this embodiment, each recessed portion 81b has a substantially circular shape as viewed from the inner peripheral surface side of the intermediary transfer belt 6. When a contact area between the potential regulating member 8 and the inner peripheral surface of the intermediary transfer belt 6 can be sufficiently decreased (preferably when the above-described contact area decrease amount can be achieved), a size of each recessed portion 81b and an interval (pitch) between adjacent recessed portions 81b can be appropriately set. An interval (pitch) d5 between the recessed portions 81b with respect to the feeding direction (and the widthwise direction) of the intermediary transfer belt 6 can be set to about 0.1 to 3 mm, and in this embodiment, from a viewpoint of processing accuracy, the interval (pitch) d5 may preferably be about 1 to 3 mm. Further, a diameter w5 of the recessed portion 81b as viewed from the inner peripheral surface side of the intermediary transfer belt 6 can be set to, for example, about 0.1 to 3 mm, and in this embodiment, from a viewpoint of processing accuracy or the like, the diameter w5 may preferably be about 1 to 3 mm. In addition, a depth h5 of the recessed portion 81b (a height of the projected portion 81a) can be set to about 0.05 to 1 mm, and in a constitution of this embodiment, from the viewpoint of the processing accuracy or the like, the height h5 may preferably be about 0.05 to 0.5 mm. Further, the height h5 of the recessed portion 81b may preferably be substantially constant in the contact surface 83. Further, a bottom of the recessed portion 81b may also be nonflat. Further, in this embodiment, a region of the projected portion 81a is equal to a region other than the recessed portion 81b, and a surface thereof opposing the intermediary transfer belt 6 is flat.

The contact surface 83 of the potential regulating member 8 has such an uneven shape, so that the contact area between the potential regulating member 8 and the inner peripheral surface of the intermediary transfer belt 5 can be decreased. Further, the uneven shape in this embodiment has an advantage such that flatness of the contact region of the contact surface 83 contactable to the inner peripheral surface of the intermediary transfer belt 6 is readily realized.

Incidentally, in this embodiment, the recessed portion 81b has the substantially circular shape when the projected portion 81a is viewed from the inner peripheral surface side of the intermediary transfer belt 6, but the shape of the recessed portion 81b is not limited thereto. This shape is arbitrary when the contact area between the potential regulating member 8 and the inner peripheral surface of the intermediary transfer belt 6 can be sufficiently decreased (preferably, the above-described contact area decrease amount can be achieved). For example, this shape may be polygons such as a triangle, a quadrangle (square, rectangle), a pentagon, and a hexagon, or a circle, an ellipse, an oval, and the like. The recessed portions 81b may have the substantially same shape for all thereof or may have different shapes for at least a part thereof. Here, in this embodiment, in the case where the shape of the projected portion 81a is a shape, other than the circle, such as the polygons, for example, a diameter of a circumscribed circle thereof can be made equal to the diameter of the circular recessed portion 81b.

Further, as described in the embodiment 1, the contact surface 83 of the potential regulating member 8 can be provided with the uneven shape by an available arbitrary method. In this embodiment, the first portion 81 of the potential regulating member 8 constituted by a metal plate of about 2 mm in thickness is subjected to the pressing, so that the uneven shape was formed on the contact surface 83. This pressing can be performed, for example, in a manner of half piercing of a metal plate.

As described above, also by a constitution of this embodiment, similarly as the embodiments 1 to 4, in a constitution in which the bias is applied to the potential regulating member 8 disposed on the side downstream of the primary transfer portion N1, it is possible to suppress that the traveling property of the intermediary transfer belt 6 becomes unstable. Further, the constitution of this embodiment readily provide flatness of the contact region of the potential regulating member 8 contactable to the inner peripheral surface of the intermediary transfer belt 6.

### Other embodiments

As described above, the present disclosure was described based on a specific embodiments, but is not limited to the above-described embodiments.

In the embodiments 1 to 5, the surface shape of the contact surface 83 was described on the assumption that the potential regulating member 8 is constituted only by the electroconductive metal such as SUS (stainless steel), but as described in the embodiment 1, the constitution of the potential regulating member 8 is not limited thereto. For example, as shown in FIG. 4, the potential regulating member 8 may also have a constitution including a base portion 84 having a shape similar to the shape of the potential regulating member 8 shown in FIG. 3 and an electroconductive surface layer 85 which is provided on a surface of the base portion 84 and which is constituted by metal or electroconductive resin. In the case of this constitution, the surface layer 85 may only be required to have the uneven shapes ("embossed shape", "lateral band shape", "vertical band shape", "inclined shape", and the like) as described in the embodiments 1 to 5. By this, similarly as in the embodiments 1 to 5, the electrostatic adsorption force between the intermediary transfer belt 6 and the potential regulating member 8 can be reduced. Further, for example, as shown in FIG. 5, the potential regulating member 8 may also be constituted so that the contact surface 83 is formed of an electroconductive nonwoven fabric 86. In the case of this constitution, by fixing the electroconductive nonwoven fabric 86 in alignment with the projected portions 81a of the surface layer 85 having the uneven shape ("embossed shape", "lateral band shape", "vertical band shape", "inclined shape", and the like) as described in the embodiments 1 to 5, an effect similar to those of the embodiments 1 to 5 can be obtained. In this case, a ratio of a decrease amount of a contact area of the contact surface 83 with the inner peripheral surface of the intermediary transfer belt 6 in the case where the surface layer 85 is provided the uneven shape and the projected portions 81a is provided with the nonwoven fabric 86 or the like to a contact area of the contact surface 83 with the inner peripheral surface of the intermediary transfer belt 6 in the case where the surface layer 85 not provided with the uneven shape is provided with the nonwoven fabric 86 or the like can be defined as a contact area decrease amount (%). However, this contact area decrease amount (%) can be regarded as being substantially equal to a contact area decrease amount (%) in the case where the surface layer 85 having the uneven shape is assumed as the contact surface 83.

Further, the surface shape of the contact surface 83 of the potential regulating member 8 may also be surface shapes as shown in parts (a) and (b) of FIG. 12, for example. Parts (a) and (b) of FIG. 12 are schematic plan views each showing a potential regulating member 8 in another embodiment in which a contact surface 83 of the potential regulating member 8 is viewed from the inner peripheral surface side of the intermediary transfer belt 6. Incidentally, for convenience, in part (a) of FIG. 12, a recessed portion 81b is denoted by dots. In the embodiment shown in part (a) of FIG. 12, the potential regulating member 8 includes projected portions 81a similar to those in the embodiment 1, and in addition, the projected portions 81a in each line with respect to the feeding direction of the intermediary transfer belt 6 are provided so that at least a part of the projected portions 81a in adjacent lines overlap with each other with respect to the widthwise direction of the intermediary transfer belt 6. Further, in the embodiment shown in part (b) of FIG. 12, a region of the recessed portions 81b in the embodiment 5 is changed to projected portions 81a, and a region of the projected portion 81a in the embodiment 5 is changed to a recessed portion 81b. Also, in the embodiment shown in part (b) of FIG. 12, the projected portions 81a in each line with respect to the feeding direction of the intermediary transfer belt 6 are provided so that at least a part of the projected portions 81a in adjacent lines overlap with each other with respect to the widthwise direction of the intermediary transfer belt 6. Thus, in each of the embodiments shown in parts (a) and (b) of FIG. 12, the contact surface 83 is provided with the projected portions 81a in the staggered pattern (staggered embossing). Such a surface shape is advantageous for removing the foreign matter from the inner peripheral surface of the intermediary transfer belt 6 by the potential regulating member 8. Further, the projected portions 81a do not extend continuously along the widthwise direction of the intermediary transfer belt 6, so that the foreign matter is suppressed from remaining on the potential regulating member 8.

Further, in the above-described embodiments, the uneven shape of the contact surface of the potential regulating member 8 is provided regularly but may also be provided irregularly (randomly). Also, in this case, the contact area decrease amount (%) may preferably be similar to those in the above-described embodiments.

Further, the surface shape of the contact surface of the potential regulating member provided for at least a part of the plurality of image forming units may be different from the surface shape of the contact surface of the potential regulating member provided for at least another part of the plurality of image forming units. For each of the potential regulating members provided for the image forming units, the surface shape of the contact surface may also be different from each other.

Further, in each of the above-described embodiments, the potential regulating member 8 has the constitution including the first portion 81 and the second portion 82, but the potential regulating member 8 may also be constituted by, for example, a flat plate corresponding to the first portion 81 in each of the above-described embodiments. Further, the potential regulating member 8 may have another form such as a black-like member having a rectangular shape, for example.

Further, in the above-described embodiments, the primary transfer member was the roller-shaped member, but may also be a brush-like member, a sheet-like member, a pad-like member, and the like.

Further, in the above-described embodiments, the potential regulating power source was provided independently for each of the image forming units, but may also be made common to the plurality (or all) of image forming units. The same applies to the charging power source, the developing power source, and the primary transfer power source.

Further, in the above-described embodiments, the predetermined charge polarity of the photosensitive member was the negative polarity, but is not limited thereto. The predetermined charge polarity of the photosensitive member may also be the positive polarity. Similarly, in the above-described embodiments, the normal charge polarity of the toner was the negative polarity, but may also be the positive polarity. Various applied voltages in the case where the predetermined charge polarity of the photosensitive member and the normal charge polarity of the toner are the positive polarity may only be required to be appropriately changed such that these polarities are changed to the polarity opposite to the polarity in the above-described embodiments in accordance with the above-described embodiments.

Further, the image forming apparatus can have a constitution including the potential regulating member for at least one of the plurality of image forming units. That is, the image forming apparatus can have a constitution in which the potential regulating member is provided on the inner peripheral surface side of the intermediary transfer belt in a position immediately close to at least one of the plurality of primary transfer portions on a side downstream of the associated primary transfer portion.

Further, the image forming apparatus is not limited to the image forming apparatus capable of forming a full-color image, but may also be an image forming apparatus capable of forming only a monochromatic (white/black or monocolor) image.

According to the present disclosure in a constitution in which a bias is applied to an electrode member disposed on a side downstream of a primary transfer portion, it is possible to suppress that a traveling property of an intermediary transfer belt becomes unstable.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-188678, filed on October 25, 2024, which is hereby incorporated by reference herein in its entirety.

What is claimed is:

1. An image forming apparatus comprising:
a photosensitive member capable of being electrically charged to a predetermined polarity and configured to bear a toner image;
an intermediary transfer belt configured to convey the toner image transferred from the photosensitive member and capable of being circulated and moved;
a transfer member forming a transfer portion, where the photosensitive member and the intermediary transfer belt contact each other, in contact with an inner peripheral surface of the intermediary transfer belt, and configured to transfer the toner image from the photosensitive member onto the intermediary transfer belt in the transfer portion under application of a voltage;
an electrode member provided on a side downstream of the transfer portion with respect to a movement direction of the intermediary transfer belt and on an inner peripheral surface side of the intermediary transfer belt; and
a power source configured to apply a voltage of the same polarity as a predetermined polarity to the electrode member,
wherein the electrode member has an uneven shape formed on a surface thereof opposing the inner peripheral surface of the intermediary transfer belt so that a plurality of contact portions each surface-contacting the inner peripheral surface of the intermediary transfer belt and a plurality of non-contact portions each in non-contact with the inner peripheral surface of the intermediary transfer belt are alternately formed with respect to a predetermined direction along the surface of the electrode member.

2. The image forming apparatus according to claim 1, wherein the electrode member is provided with a plurality of projected portions arranged in the predetermined direction and forming a contact region in which the plurality of projected portions surface-contact the inner peripheral surface of the intermediary transfer belt and with at least one recessed portion provided between the plurality of projected portions and forming a non-contact region when the plurality of projected portions contact the intermediary transfer belt.

3. The image forming apparatus according to claim 2, wherein each of the projected portions is provided with a flat surface portion surface-contacting the inner peripheral surface of the intermediary transfer belt.

4. The image forming apparatus according to claim 2, wherein the electrode member is provided with the plurality of projected portions each including the contact portion and which are independent of each other.

5. The image forming apparatus according to claim 2, wherein the plurality of projected portions are provided so as to linearly extend along the movement direction.

6. The image forming apparatus according to claim 2, wherein the plurality of projected portions are provided so as to linearly extend in a direction substantially perpendicular to the movement direction.

7. The image forming apparatus according to claim 2, wherein the plurality of projected portions are provided so as to linearly extend while being inclined relative to the movement direction.

8. The image forming apparatus according to claim 2, wherein the plurality of projected portions are provided so that at least a part of each of the projected portions adjacent to each other overlap with each other with respect to a direction substantially perpendicular to the movement direction.

9. The image forming apparatus according to claim 2, wherein the at least one recessed portion comprises a plurality of recessed portions provided between the plurality of projected portions.

10. The image forming apparatus according to claim 2, wherein a height of each of the plurality of projected portions is 0.05 mm to 1 mm.

11. The image forming apparatus according to claim 1, wherein a distance, from a most upstream end to a most downstream end of the contact portion, which is a contact width of the electrode member with respect to the movement direction is 5 mm or more and 50 mm or less.

12. The image forming apparatus according to claim 1, wherein the predetermined direction is a direction along the movement direction.

13. The image forming apparatus according to claim 1, wherein the predetermined direction is a direction crossing the movement direction.

14. The image forming apparatus according to claim 2, wherein the electrode member is constituted so that the contact region and the non-contact region exist in a cross section when the electrode member is cut along the movement direction.

15. The image forming apparatus according to claim 2, wherein the electrode member is provided so that the contact region exists in at least a part thereof with respect to the movement direction in any position of a maximum image forming region with respect to a direction substantially perpendicular to the movement direction in a cross section when the electrode member is cut along the movement direction.

16. The image forming apparatus according to claim 2, wherein in a case where a unit region in an arbitrary position in a maximum image forming region with respect to a direction substantially perpendicular to the movement direction is taken, the electrode member has a ratio of an area of the non-contact region in the unit region to an area of the unit region is 10 % or more and 70 % or less.

17. The image forming apparatus according to claim 16, wherein the ratio is 20 % or more and 50 % or less.
